(19) United States
(12) Patent Application Publication
(10) Pub. No.: US 2024/0386669 A1
(43) Pub. Date: Nov. 21, 2024

(54) METHOD AND APPARATUS FOR DETERMINING VERTEX AMBIENT OCCLUSION VALUE, METHOD AND APPARATUS FOR APPLYING VERTEX AMBIENT OCCLUSION VALUE, AND DEVICE

(71) Applicant: Tencent Technology (Shenzhen) Company Limited, Shenzhen (CN)

(72) Inventors: Yibin WANG, Shenzhen (CN); Cheng LIAO, Shenzhen (CN)

(73) Assignee: Tencent Technology (Shenzhen) Company Limited, Shenzhen (CN)

(21) Appl. No.: 18/786,190

(22) Filed: Jul. 26, 2024

Related U.S. Application Data
(63) Continuation of application No. PCT/CN2023/121850, filed on Sep. 27, 2023.

(30) Foreign Application Priority Data
Oct. 24, 2022 (CN) 202211299166.9

(51) Int. Cl. G06T 17/00; G06V 10/26

(52) U.S. Cl. CPC G06T 17/00; G06V 10/26

(57) ABSTRACT

A method includes performing a triangular surface segmentation on a to-be-processed model to obtain a triangular surface model, the triangular surface model includes a plurality of triangles and a plurality of vertices, each triangle is associated with three vertices that are connected by connecting edges. The method also includes calculating ambient occlusion values respectively of the plurality of vertices, a first ambient occlusion value of a first vertex is calculated based on first one or more triangles associated with the first vertex. The method also includes calculating errors respectively associated with a plurality of connecting edges based on ambient occlusion values of the plurality of vertices, and collapsing a first connecting edge between two vertices based on the errors to obtain a simplified triangular surface model. Apparatus and non-transitory computer-readable storage medium counterpart embodiments are also contemplated.

### RELATED APPLICATIONS

The present application is a continuation of International Application No. PCT/CN2023/121850, entitled “VERTEX AMBIENT OCCLUSION VALUE DETERMINATION METHOD AND APPARATUS, VERTEX AMBIENT OCCLUSION VALUE APPLICATION METHOD AND APPARATUS, AND DEVICE” and filed on Sep. 27, 2023, which claims priority to Chinese Patent Application No. 202211299166.9, entitled “METHOD AND APPARATUS FOR DETERMINING VERTEX AMBIENT OCCLUSION VALUE, METHOD AND APPARATUS FOR APPLYING VERTEX AMBIENT OCCLUSION VALUE, AND DEVICE” filed on Oct. 24, 2022. The entire disclosures of the prior applications are hereby incorporated by reference.

### FIELD OF THE TECHNOLOGY

Embodiments of this disclosure relate to the field of image processing technologies, including a technology for determining a vertex ambient occlusion value.

### BACKGROUND OF THE DISCLOSURE

With the rapid development of internet technologies, people have increasingly high requirements for image realism in products or works (for example, three-dimensional animation or game images) that people can experience in life. The realism of an image greatly depends on the physical realism of an illumination model. The representation of ambient occlusions (AOs) is one very important measure of increasing image realism.

Ambient occlusions may generate important visual shading, and shadows generated between objects due to occlusions are depicted, to better capture details in a scene, solve problems such as light leakage and shadow floating, mitigate problems such as unclear shadows of tiny objects such as corners, gears, and cracks in the scene, and enhance the depth and perception of three-dimensionality of the scene.

At present, the occlusions of each sampling point in a model are usually calculated in a fragment shader in real time, and is compared with a depth map to determine a final AO value of a fragment. However, the technology is a very expensive rendering technology and requires a massive calculation amount, and as a result high costs need to be consumed in memory usage or runtime in terms of overheads.

### SUMMARY

Embodiments of this disclosure provide a method and an apparatus for determining a vertex ambient occlusion value, a method and an apparatus for applying a vertex ambient occlusion value, and a device, so that an ambient occlusion value of a valid target vertex on a surface of a model can be obtained more accurately, calculation complexity is low, memory usage can be reduced, operational costs are effectively reduced, and the optimization of creating an ambient occlusion value on the surface of the model is further implemented, thereby further improving the picture quality performance of the model in subsequent rendering.

An aspect of embodiments of this disclosure provides a method for determining a vertex ambient occlusion value. The method includes performing a triangular surface segmentation on a to-be-processed model to obtain a triangular surface model, the triangular surface model includes a plurality of triangles and a plurality of vertices, each triangle is associated with three vertices that are connected by connecting edges. The method also includes calculating ambient occlusion values respectively of the plurality of vertices, a first ambient occlusion value of a first vertex is calculated based on first one or more triangles associated with the first vertex. The method also includes calculating errors respectively associated with a plurality of connecting edges based on ambient occlusion values of the plurality of vertices, and collapsing a first connecting edge between two vertices (e.g., into a single vertex) based on the errors to obtain a simplified triangular surface model. Apparatus and non-transitory computer-readable storage medium counterpart embodiments are also contemplated.

Another aspect of this disclosure provides a method for applying a vertex ambient occlusion value, including:

generating an ambient occlusion value of each target vertex in a target triangular surface model by using the foregoing method;

acquiring a normal corresponding to each target vertex, and storing the ambient occlusion value in an encoding channel of the normal;

decoding the normal by using a shader to obtain a normal vector and the ambient occlusion value;

calculating an illumination vector from a surface of the target triangular surface model to a light source position based on the normal vector; and

performing rendering based on the illumination vector and the ambient occlusion value to obtain a target rendering image corresponding to the target triangular surface model.

Another aspect of this disclosure provides an apparatus for determining a vertex ambient occlusion value, including:

an acquisition unit, configured to perform a triangular surface segmentation on a to-be-processed model to obtain a triangular surface model, the triangular surface model including a plurality of triangles and a plurality of vertices, each triangle being associated with three vertices;

a processing unit, configured to calculate an ambient occlusion value of each vertex based on a triangle associated with each vertex;

the processing unit being further configured to calculate an error corresponding to a connecting edge between every two vertices based on the ambient occlusion value of each vertex;

the processing unit being further configured to combine the connecting edge between every two vertices based on the error corresponding to the connecting edge between every two vertices to obtain a target triangular surface model and a target vertex in the target triangular surface model; and

a determining unit, configured to calculate an ambient occlusion value of the target vertex based on a triangle associated with the target vertex.

Another aspect of this disclosure provides an apparatus for applying a vertex ambient occlusion value, including:

a generation unit, configured to generate an ambient occlusion value of each target vertex in a target triangular surface model;

an acquisition unit, configured to: acquire a normal corresponding to each target vertex, and store the ambient occlusion value in an encoding channel of the normal;

a processing unit, configured to decode the normal by using a shader to obtain a normal vector and the ambient occlusion value;

the acquisition unit being further configured to calculate an illumination vector from a surface of the target triangular surface model to a light source position based on the normal vector; and

the processing unit being further configured to perform rendering based on the illumination vector and the ambient occlusion value to obtain a target rendering image corresponding to the target triangular surface model.

Another aspect of this disclosure provides a computer device, including a memory, a processor, and a bus system,

the memory storing a computer program,

the program in the memory, when executed by the processor, implementing the method according to the foregoing aspects;

the bus system being configured to connect the memory and the processor, to cause the memory and the processor to perform communication.

Another aspect of this disclosure provides a computer-readable storage medium, the computer-readable storage medium storing instructions, when run on a computer, the instructions causing the computer to perform the method according to the foregoing aspects.

Another aspect of this disclosure provides a computer program product, including a computer program, the computer program, when executed by a processor, implementing the method according to the foregoing aspects.

It can be seen from the foregoing technical solutions that, the embodiments of this disclosure have the following beneficial effects:

A triangular surface segmentation is performed on a to-be-processed model to acquire a triangular surface model including a plurality of triangles and a plurality of vertices; an ambient occlusion value of each vertex is further calculated based on a triangle associated with each vertex; an error corresponding to a connecting edge between every two vertices is calculated based on the ambient occlusion value of each vertex; and then the connecting edge between every two vertices may be combined based on the error corresponding to the connecting edge between every two vertices to acquire a target triangular surface model and a target vertex in the target triangular surface model; and an ambient occlusion value of the target vertex is calculated based on a triangle associated with the target vertex. In the foregoing manner, the triangular surface segmentation is first performed on a surface of the model, the ambient occlusion value of each vertex in the triangular surface model after the segmentation is then calculated, and a redundant segmented triangular surface on the surface of the model is combined in combination with the error corresponding to the connecting edge between every two vertices, and a valuable triangular surface is kept, to avoid a missing ambient occlusion value at a local position when a quantity of surfaces of the model is small, so that an ambient occlusion value of a valid target vertex on a surface of a model can be obtained more accurately, calculation complexity is low, memory usage can be reduced, operational costs are effectively reduced, and the optimization of creating an ambient occlusion value on the surface of the model is further implemented, thereby further improving the picture quality performance of the model in subsequent rendering.

### BRIEF DESCRIPTION OF THE DRAWINGS

FIG. 1 is a schematic architectural diagram of an image data control system in an embodiment of this disclosure.

FIG. 2 is a flowchart of an embodiment of a method for determining a vertex ambient occlusion value in an embodiment of this disclosure.

FIG. 3 is a flowchart of an embodiment of a method for determining a vertex ambient occlusion value in another embodiment of this disclosure.

FIG. 4 is a flowchart of an embodiment of a method for determining a vertex ambient occlusion value in another embodiment of this disclosure.

FIG. 5 is a flowchart of an embodiment of a method for determining a vertex ambient occlusion value in another embodiment of this disclosure.

FIG. 6 is a flowchart of an embodiment of a method for determining a vertex ambient occlusion value in another embodiment of this disclosure.

FIG. 7 is a flowchart of an embodiment of a method for determining a vertex ambient occlusion value in another embodiment of this disclosure.

FIG. 8 is a flowchart of an embodiment of a method for determining a vertex ambient occlusion value in another embodiment of this disclosure.

FIG. 9 is a flowchart of an embodiment of a method for determining a vertex ambient occlusion value in another embodiment of this disclosure.

FIG. 10 is a flowchart of an embodiment of a method for determining a vertex ambient occlusion value in another embodiment of this disclosure.

FIG. 11 is a flowchart of an embodiment of a method for determining a vertex ambient occlusion value in another embodiment of this disclosure.

FIG. 12 is a flowchart of an embodiment of a method for determining a vertex ambient occlusion value in another embodiment of this disclosure.

FIG. 13 is a flowchart of an embodiment of a method for determining a vertex ambient occlusion value in another embodiment of this disclosure.

FIG. 14 is a flowchart of an embodiment of a method for determining a vertex ambient occlusion value in another embodiment of this disclosure.

FIG. 15 is a flowchart of an embodiment of a method for applying a vertex ambient occlusion value in an embodiment of this disclosure.

FIG. 16 is a schematic principle flowchart of a method for determining a vertex ambient occlusion value in an embodiment of this disclosure.

FIG. 17 is another schematic principle flowchart of a method for determining a vertex ambient occlusion value in an embodiment of this disclosure.

FIG. 18 is a schematic principle flowchart of acquiring sampling points in a method for determining a vertex ambient occlusion value in an embodiment of this disclosure.

FIG. 19 is a schematic diagram of acquiring sampling points in a method for determining a vertex ambient occlusion value in an embodiment of this disclosure.

FIG. 20a is a schematic diagram of a to-be-processed model in a method for determining a vertex ambient occlusion value in an embodiment of this disclosure.

FIG. 20b is a schematic diagram of a triangular surface model in a method for determining a vertex ambient occlusion value in an embodiment of this disclosure.

FIG. 20c is a schematic diagram of a target triangular surface model in a method for determining a vertex ambient occlusion value in an embodiment of this disclosure.

FIG. 21a is a schematic effect diagram after a model is rendered in a method for determining a vertex ambient occlusion value in an embodiment of this disclosure.

FIG. 21b is a schematic diagram of an effect after a target triangular surface model is rendered in a method for determining a vertex ambient occlusion value in an embodiment of this disclosure.

FIG. 22 is a schematic diagram of an embodiment of an apparatus for determining a vertex ambient occlusion value in an embodiment of this disclosure.

FIG. 23 is a schematic diagram of an embodiment of an apparatus for applying a vertex ambient occlusion value in an embodiment of this disclosure.

FIG. 24 is a schematic diagram of an embodiment of a computer device in an embodiment of this disclosure.

### DESCRIPTION OF EMBODIMENTS

Terms such as “first”, “second”, “third”, and “fourth” (if exist) in this specification, the claims, and the foregoing accompanying drawings of this disclosure are intended to distinguish between similar objects rather than describe a particular sequence or a chronological order. The data termed in such a way are interchangeable in proper circumstances, so that the embodiments of this disclosure described herein can be, for example, implemented in orders except the order illustrated or described herein. Moreover, the terms “include”, “correspond to” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

For case of understanding, some terms or concepts used in embodiments of this disclosure are first described.

1. An ambient occlusion (AO) value is an approximate value configured for describing a light brightness of a different part of a visible surface of a model.

2. A vertex AO is configured for storing AO information in a vertex attribute.

In specific implementations of this disclosure, related data such as a triangular surface model and a vertex are involved. When the foregoing embodiments of this disclosure are used in specific products or technologies, user permissions or agreements need to be obtained, and the collection, use and processing of relevant data need to comply with the relevant laws, regulations, and standards of the relevant countries and regions.

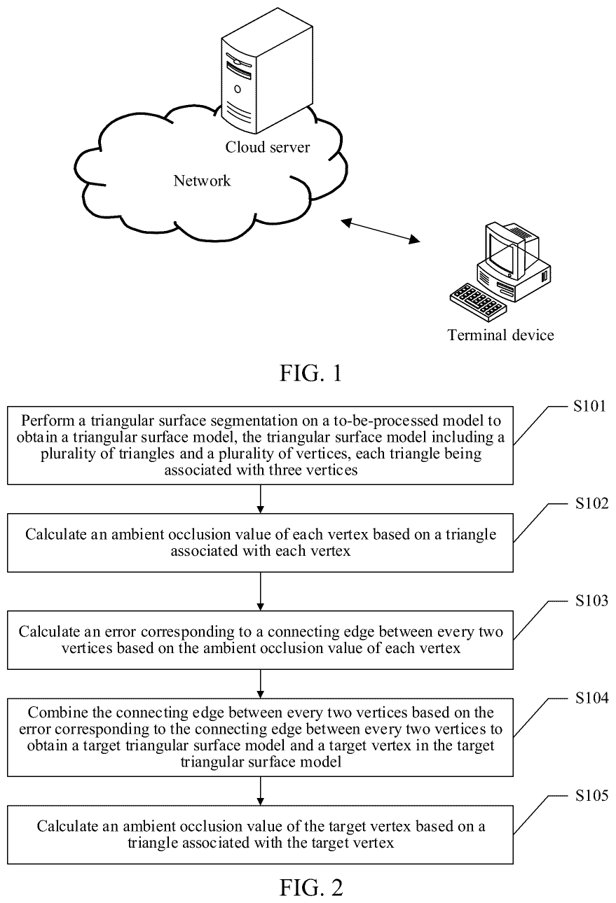

This disclosure provides a method for determining a vertex ambient occlusion value. The method may be applied to an image data control system shown in FIG. 1. FIG. 1 is a schematic architectural diagram of an image data control system in an embodiment of this disclosure. As shown in FIG. 1, a server performs a triangular surface segmentation on a to-be-processed model provided by a terminal device to acquire a triangular surface model including a plurality of triangles and a plurality of vertices; an ambient occlusion value of each vertex may be further calculated based on a triangle associated with each vertex; an error corresponding to a connecting edge between every two vertices is calculated based on the ambient occlusion value of each vertex; and then the connecting edge between every two vertices may be combined (also referred to as collapsed, simplified) based on the error corresponding to the connecting edge between every two vertices to acquire a target triangular surface model and a target vertex (also referred to as combined vertex or collapsed vertex) in the target triangular surface model; and an ambient occlusion value of the target vertex is calculated based on a triangle associated with the target vertex. In the foregoing manner, the triangular surface segmentation can be first performed on a surface of the model, the ambient occlusion value of each vertex in the triangular surface model after the segmentation is then calculated, and a redundant segmented triangle on the surface of the model is combined (simplified) in combination with the error corresponding to the connecting edge between every two vertices, and a valuable triangle is kept, to avoid a missing ambient occlusion value at a local position when a quantity of surfaces of the model is small, so that an ambient occlusion value of a valid target vertex on a surface of a model can be obtained more accurately, calculation complexity is low, memory usage can be reduced, operational costs are effectively reduced, and the optimization of creating an ambient occlusion value on the surface of the model is further implemented, thereby further improving the picture quality performance of the model in subsequent rendering.

FIG. 1 shows only a terminal device. In actual scenarios, more types of terminal devices may participate in a process of data processing. The terminal device includes, but not limited to, a mobile phone, a computer, a smart speech interaction device, a smart home appliance, an in-vehicle terminal, and the like. A specific quantity and specific types are determined by actual scenarios, and are not specifically limited herein. In addition, FIG. 1 shows one server. However, in actual scenarios, a plurality of servers may participate, and a quantity of servers is determined by actual scenarios, and is not specifically limited herein.

In this embodiment, the server may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device and the server may be directly or indirectly connected in a wired or wireless communication manner, and the terminal device and the server may be connected to form a blockchain network. This is not limited in this disclosure.

A method for determining a vertex ambient occlusion value in this disclosure is described below with reference to the foregoing description. An execution entity of the method for determining a vertex ambient occlusion value may be a computer device, for example, a terminal device or a server. Referring to FIG. 2, an embodiment of a method for determining a vertex ambient occlusion value in an embodiment of this disclosure includes the following operations:

Operation S101: Perform a triangular surface segmentation on a to-be-processed model to obtain a triangular surface model, the triangular surface model including a plurality of triangles and a plurality of vertices, each triangle being associated with three vertices.

In this embodiment, because any figure may be formed by splicing triangular surfaces, when a triangular surface model is acquired, a triangular surface segmentation may be performed on the to-be-processed model to acquire a triangular surface model including a plurality of triangles and vertices forming the triangles.

The to-be-processed model is the basis of a visible object in a three-dimensional game scene, a three-dimensional animation scene, or the like. The to-be-processed model may be specifically represented as a character, a house, a tree, a mountain, a river, or the like. Most visible objects are formed with a model as the basis.

A triangular surface (which may also be referred to as a triangle) is a basic polygon that is formed by three vertices and can be conveniently processed by a computer device. A triangular surface formed by three points is definitely in a same plan in a three-dimensional space, and a polygon formed by four or more points is not necessarily in a same plan in a three-dimensional space. Therefore, a triangular surface may be considered as the most basic polygon, so that subsequently valid vertices on a to-be-processed model can be better determined, and ambient occlusion values of the vertices can be acquired more accurately.

A mesh is formed by one triangular surface or by splicing a plurality of triangular surfaces, and is the basis of building a model shape. To be specific, a set of data of vertices of triangular surfaces forming various figures and shapes and index data of the triangular surfaces is a mesh. A to-be-processed model may be formed by a mesh and a material. The basis of the to-be-processed model is a mesh, and the basis of the mesh is a triangular surface. Therefore, when the to-be-processed model has more triangular surfaces, the to-be-processed model can represent richer details.

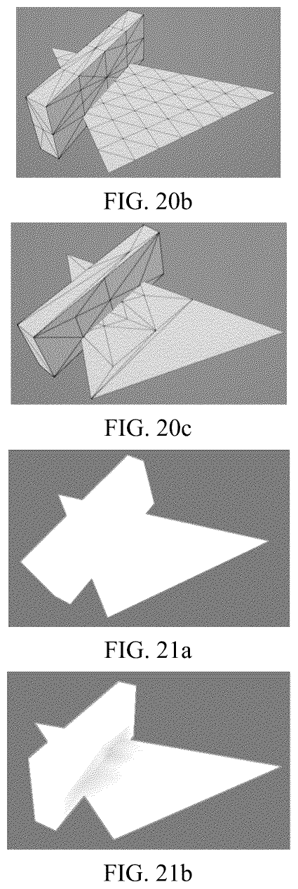

Specifically, when a to-be-processed model (a to-be-processed model shown in FIG. 20a) is acquired, a triangular surface segmentation may be performed on the to-be-processed model. A triangular surface segmentation may be specifically performed on the to-be-processed model by using the Mesh component in Unity, so that a mesh that includes usable attributes and functions such as vertex coordinates, normals, texture coordinates, and a triangle drawing sequence can be obtained. Next, the mesh obtained through the segmentation may be rendered by using a mesh renderer to acquire a triangular surface model (a triangular surface model shown in FIG. 20b) including a plurality of triangles and vertices forming the triangles, and vertex coordinates of each vertex, a normal of a plane of each triangle, texture coordinates of each triangle, and a triangle drawing sequence corresponding to each triangle may be obtained. The triangle drawing sequence is configured for indicating a subsequent rendering orientation. In actual application, a triangular surface segmentation may be performed on the to-be-processed model by using another component, which is not specifically limited herein.

Operation S102: Calculate an ambient occlusion value of each vertex based on a triangle associated with each vertex.

In this embodiment, after the triangular surface model is acquired, the triangle associated with each vertex is acquired, and then the ambient occlusion value of each vertex may be calculated based on the triangle associated with each vertex.

The ambient occlusion value is configured for generating visual shading to depict shadows generated between objects due to occlusions. Based on the ambient occlusion value, details of the triangular surface model in a scene can be better captured, so that problems such as light leakage and shadow floating can be solved. For example, problems such as unclear shadows of tiny objects such as corners, gears, and cracks in a game scene can be mitigated, and the depth and perception of three-dimensionality of the scene can be enhanced.

The representation of the ambient occlusion value in a rendered graphic can be intuitively reflected in the shading of a picture. If an ambient occlusion special effect is not enabled, the illumination of the picture is slightly brighter. After the ambient occlusion special effect is enabled, local detailed pictures, especially dark shadows, are clearer.

Specifically, after the triangular surface model is acquired, the triangle associated with each vertex is acquired, and then an occlusion factor, i.e., a current ambient occlusion value of each vertex, may be calculated for each vertex based on the triangle associated with each vertex by using an occlusion factor algorithm. The occlusion factor is configured for representing a probability that all outgoing light from the vertex is blocked by another object. A good occlusion factor may add fine shading to a picture to greatly enhance the realism of the picture.

Operation S103: Calculate an error corresponding to a connecting edge between every two vertices based on the ambient occlusion value of each vertex.

In this embodiment, if a quantity of triangles in the triangular surface model after the segmentation is small, ambient occlusions at local positions on the surface of the triangular surface model tend to be missing, and important visual shading may fail to be generated in a graphic obtained through subsequent rendering (FIG. 21a shows a rendering effect of a triangular surface model with an inappropriate segmentation of triangular surfaces or a small quantity of triangular surfaces after a segmentation). In this embodiment, the error corresponding to the connecting edge between every two vertices is calculated based on the ambient occlusion value of each vertex, so that subsequently a redundant segmented triangular surface in the triangular surface model may be combined through iteration based on the error, so that a valuable triangular surface is kept, to implement the optimization of creating an ambient occlusion value on the local surface of the triangular surface model.

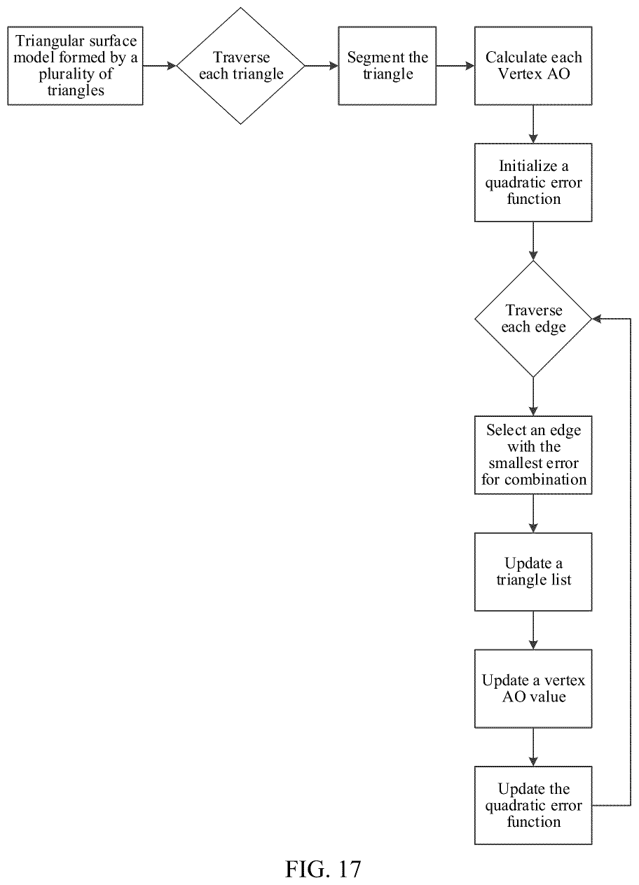

Specifically, as shown in FIG. 17, a segmentation may be performed on the surface of the to-be-processed model, and the ambient occlusion value of each vertex in the triangular surface model after the segmentation is then calculated. Next, the error corresponding to the connecting edge between every two vertices may be calculated based on the ambient occlusion value of each vertex by using, for example, a quadratic error metric method. In actual application, the error corresponding to the connecting edge between every two vertices may be calculated by using another error algorithm, which is not specifically limited herein.

Operation S104: Combine the connecting edge between every two vertices based on the error corresponding to the connecting edge between every two vertices to obtain a target triangular surface model and a target vertex in the target triangular surface model.

In this embodiment, after the error corresponding to the connecting edge between every two vertices is acquired, a redundant segmented triangular surface in the triangular surface model may be combined through iteration based on the error, so that a valuable triangular surface is kept, to acquire a combined target triangular surface model and a target vertex in the target triangular surface model, thereby implementing the optimization of creating an ambient occlusion value on the local surface of the triangular surface model.

Specifically, as shown in FIG. 17, after the error corresponding to the connecting edge between every two vertices is acquired, a connecting edge corresponding to a current smallest error is selected from the error corresponding to the connecting edge between every two vertices, and then the connecting edge corresponding to the current smallest error is combined to acquire a current combined updated triangular surface model. An updated error corresponding to a connecting edge between every two vertices in the updated triangular surface model is recalculated in a next round of iteration, and the connecting edge in the updated triangular surface model is combined according to the updated error. This process is repeated, and the iteration ends when the updated error in the iteration is greater than or equal to an error threshold, to acquire the target triangular surface model (a target triangular surface model shown in FIG. 20c) and the target vertex (a vertex in the target triangular surface model shown in FIG. 20c) in the target triangular surface model.

Operation S105: Calculate an ambient occlusion value of the target vertex based on a triangle associated with the target vertex.

In this embodiment, after the target triangular surface model is acquired, a triangle associated with each target vertex is acquired, and then an ambient occlusion value of each target vertex may be calculated based on the triangle associated with each target vertex.

Specifically, after the target triangular surface model is acquired, the triangle associated with each target vertex is acquired, and then an occlusion factor, i.e., a current ambient occlusion value of each target vertex, may also be calculated for each target vertex based on the triangle associated with each target vertex by using an occlusion factor algorithm.

Further, the triangular surface segmentation is first performed on a surface of the model, the ambient occlusion value of each vertex in the triangular surface model after the segmentation is then calculated, and a redundant segmented triangular surface on the surface of the model is combined in combination with the error corresponding to the connecting edge between every two vertices, and a valuable triangular surface is kept, to acquire the target triangular surface model and calculate the ambient occlusion value of the target vertex. Subsequently, subsequent rendering may be performed based on the target triangular surface model and the ambient occlusion value of the target vertex to obtain a corresponding graphic (FIG. 21b shows a rendering effect of a target triangular surface model, and clear shading exists on the surface of the middle of the model).

The ambient occlusion value is a floating-point number. Therefore, when more self-occlusions exist, the ambient occlusion value further approximates to 0, or otherwise further approximates to 1.0. To be specific, it can be seen that if a quantity of surfaces in the triangular surface model after the segmentation is small, nearly all ambient occlusion values generated in the middle region of the graphic (FIG. 21a shows a rendering effect of a triangular surface model with an inappropriate segmentation of triangular surfaces or a small quantity of triangular surfaces after a segmentation) obtained through rendering approximate to 1.0, indicating that ambient occlusion values cannot be correctly generated in this case. The triangular surface segmentation is first performed on a surface of the model, the ambient occlusion value of each vertex in the triangular surface model after the segmentation is then calculated, and a redundant segmented triangular surface on the surface of the model is combined in combination with the error corresponding to the connecting edge between every two vertices, and a valuable triangular surface is kept, to acquire the target triangular surface model. A corresponding graphic (FIG. 21b shows a rendering effect of a target triangular surface model, and clear shading exists on the surface of the middle of the model) obtained through rendering can display clear shading in the middle of the model, to be specific, ambient occlusion values are correctly generated, so that the picture quality performance after rendering can be further enhanced.

In the embodiments of this disclosure, a method for determining a vertex ambient occlusion value is provided. In the foregoing manner, the triangular surface segmentation can be first performed on a surface of the model, the ambient occlusion value of each vertex in the triangular surface model after the segmentation is then calculated, and a redundant segmented triangular surface on the surface of the model is combined in combination with the error corresponding to the connecting edge between every two vertices, and a valuable triangular surface is kept, to avoid a missing ambient occlusion value at a local position when a quantity of surfaces of the model is small, so that an ambient occlusion value of a valid target vertex on a surface of a model can be obtained more accurately, calculation complexity is low, memory usage can be reduced, operational costs are effectively reduced, and the optimization of creating an ambient occlusion value on the surface of the model is further implemented, thereby further improving the picture quality performance of the model in subsequent rendering.

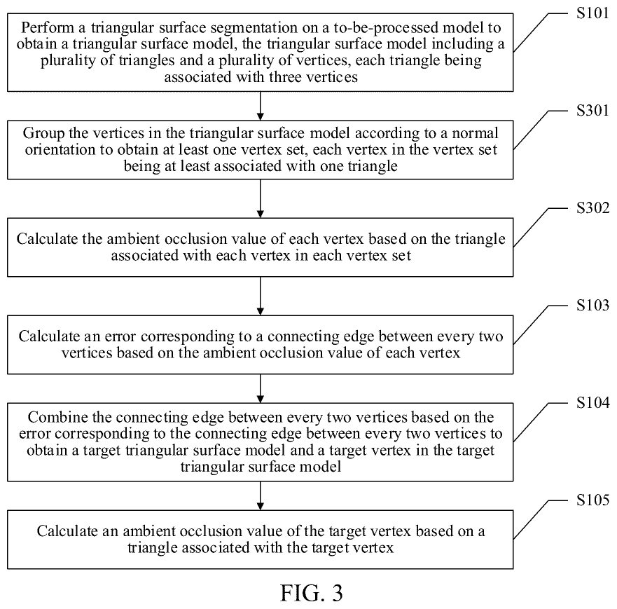

In some embodiments, based on the foregoing embodiment corresponding to FIG. 2, in another embodiment of a method for determining a vertex ambient occlusion value provided in embodiments of this disclosure, as shown in FIG. 3, Operation S102 of calculating an ambient occlusion value of each vertex based on a triangle associated with each vertex includes the following operations:

Operation S301: Group the vertices in the triangular surface model according to a normal orientation to obtain at least one vertex set, each vertex in the vertex set being at least associated with one triangle.

Operation S302: Calculate the ambient occlusion value of each vertex based on the triangle associated with each vertex in each vertex set.

In this embodiment, after the triangular surface model is acquired, the vertices in the triangular surface model may be grouped according to the normal orientation to acquire at least one vertex set, and then, for each vertex in each vertex set, an ambient occlusion value of the vertex is calculated based on a triangle associated with the vertex. In this way, the vertices in the triangular surface model are grouped based on a normal orientation of a surface normal of the triangle associated with each vertex in the triangular surface model, to ensure that vertex ambient occlusion values at a same position are consistent, thereby avoiding an unsmooth effect due to interpolation in subsequent rendering.

Each vertex in the vertex set being at least associated with one triangle.

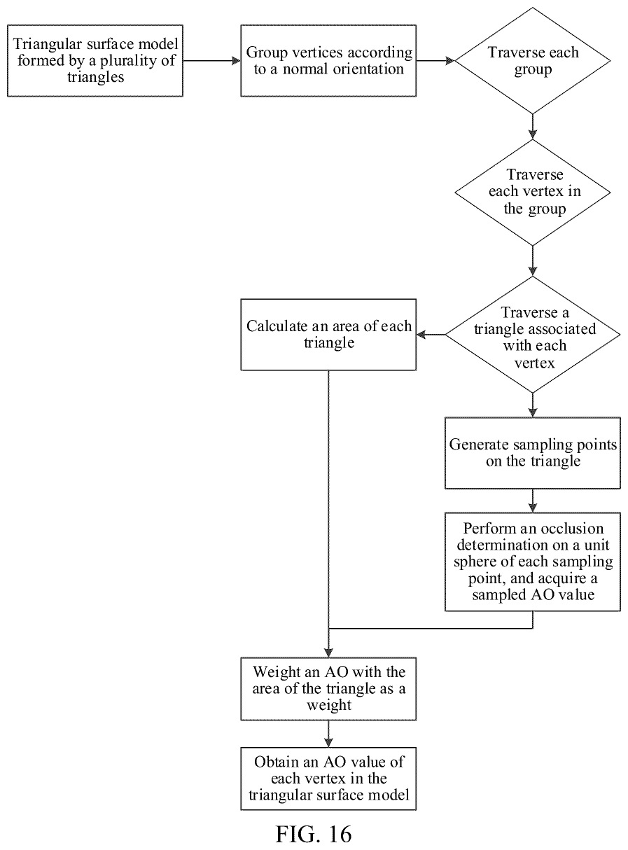

Specifically, as shown in FIG. 16, a triangular surface segmentation and rendering are performed on the to-be-processed model according to the foregoing Mesh component in Unity, to acquire a triangular surface model (a triangular surface model shown in FIG. 20b) including a plurality of triangles and vertices forming the triangles, and vertex coordinates of each vertex, a normal of a plane of each triangle, texture coordinates of each triangle, and a triangle drawing sequence corresponding to each triangle may be obtained. Subsequently, the vertices in the triangular surface model may be grouped according to a normal orientation of the normal of the plane of each triangle to acquire at least one vertex set. Next, as shown in FIG. 16, each vertex set may be traversed, and each vertex in each vertex set may be traversed. Traversal of an associated triangle is performed on each traversed vertex, to obtain the triangle associated with each vertex through the traversal, and further, based on the triangle associated with each vertex, an ambient occlusion value of the vertex may be calculated.

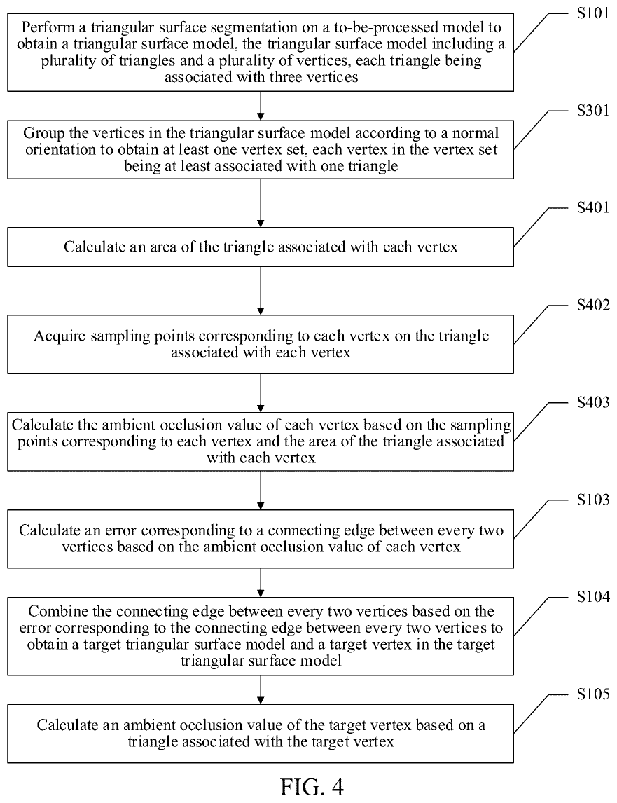

In some embodiments, based on the foregoing embodiment corresponding to FIG. 3, in another embodiment of a method for determining a vertex ambient occlusion value provided in embodiments of this disclosure, as shown in FIG. 4, Operation S302 of calculating the ambient occlusion value of each vertex based on the triangle associated with each vertex in each vertex set includes the following operations:

Operation S401: Calculate an area of the triangle associated with each vertex.

Operation S402: Acquire sampling points corresponding to each vertex on the triangle associated with each vertex.

Operation S403: Calculate the ambient occlusion value of each vertex based on the sampling points corresponding to each vertex and the area of the triangle associated with each vertex.

In this embodiment, after the vertices in the triangular surface model are grouped to obtain at least one vertex set, for each vertex in each vertex set, an area of a triangle associated with the vertex may be first calculated, and sampling points corresponding to the vertex are acquired on the triangle associated with the vertex. Next, the ambient occlusion value of each vertex may be calculated based on the sampling points corresponding to each vertex and the area of the triangle associated with each vertex. In this way, through the generated sampling points, a case that all outgoing light from the sampling points is blocked by another object is better captured, so that the occlusion factor of each vertex, i.e., the ambient occlusion value of each vertex, can be better calculated.

Specifically, as shown in FIG. 16, the vertices in the triangular surface model are grouped to obtain at least one vertex set, for each vertex in each vertex set, an area of a triangle associated with the vertex may be first calculated. Specifically, a triangular surface segmentation and rendering may be performed on the to-be-processed model according to the foregoing Mesh component in Unity, to acquire vertex coordinates of each vertex and texture coordinates of each triangle in a triangular surface model (a triangular surface model shown in FIG. 20b). Subsequently, the area of each triangle may be calculated based on the vertex coordinates of each vertex and the texture coordinates of each triangle according to a common calculation formula of the area of a triangle, so that the area of the triangle associated with each vertex may be acquired.

Further, as shown in FIG. 16, to acquire the sampling points corresponding to each vertex on the triangle associated with each vertex, an interpolation calculation is specifically performed on an opposite edge corresponding to each vertex on the triangle associated with each vertex to obtain first interpolation points of each vertex on the opposite edge as first interpolation points corresponding to each vertex, for each vertex, an interpolation calculation is then performed on a connecting edge between the vertex and each first interpolation point corresponding to the vertex to obtain second interpolation points of each vertex on the connecting edge as second interpolation points corresponding to each vertex, and then sampling is performed on the triangle associated with each vertex based on the second interpolation points corresponding to each vertex to obtain the sampling points corresponding to each vertex.

Further, the ambient occlusion value of each vertex may be calculated based on the sampling points corresponding to each vertex and the area of the triangle associated with each vertex. An occlusion determination may be performed on a unit sphere of each sampling point by using a common AO calculation formula to acquire an ambient occlusion value corresponding to each vertex surrounding each sampling point. Specifically, a normal vector corresponding to a geometric voxel (triangular surface model) outside sampling points P, a hemispherical space corresponding to each sampling point P, and a direction vector of emission of the hemisphere from each sampling point P are respectively substituted into corresponding visibility functions to perform integration, and summation and averaging are performed on integration results corresponding to each sampling point to acquire an ambient occlusion value of each vertex on the triangle associated with the vertex. To be specific, an AO value of each vertex is obtained by performing summation and averaging on local AO values on a hemisphere surrounding each sampling point P. The visibility function may be represented as a binary function, to be specific, a possible value of the visibility function is 0 or 1, or another visibility function may be used, which is not specifically limited herein. Further, to better calculate the AO value of each vertex, the integration may be discretized (for example, by using the transform of Monte Carlo integration) to improve the accuracy and feasibility of the acquired ambient occlusion value of each vertex on the associated triangle.

Further, as shown in FIG. 16, after the ambient occlusion value of each vertex on the triangle associated with the vertex is acquired, weighted averaging may be performed on the ambient occlusion value of each vertex on the triangle associated with the vertex with the area of the triangle associated with each vertex as a weight, to finally acquire the ambient occlusion value of each vertex, so that the acquired ambient occlusion value of each vertex can be smoother.

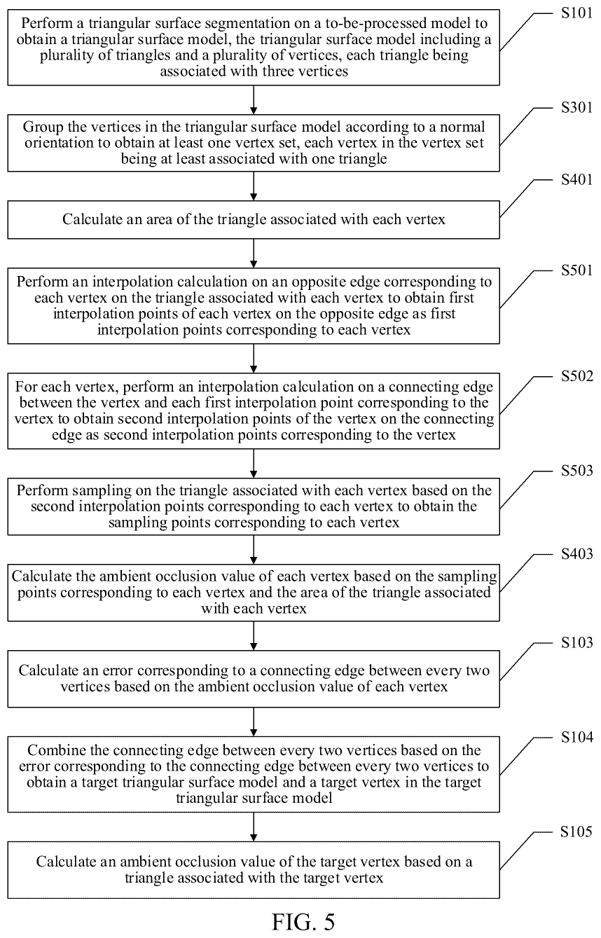

In some embodiments, based on the foregoing embodiment corresponding to FIG. 4, in another embodiment of a method for determining a vertex ambient occlusion value provided in embodiments of this disclosure, as shown in FIG. 5, Operation S402 of acquiring sampling points corresponding to each vertex on the triangle associated with each vertex includes the following operations:

Operation S501: Perform an interpolation calculation on an opposite edge corresponding to each vertex on the triangle associated with each vertex to obtain first interpolation points of each vertex on the opposite edge as first interpolation points corresponding to each vertex.

Operation S502: For each vertex, perform an interpolation calculation on a connecting edge between the vertex and each first interpolation point corresponding to the vertex to obtain second interpolation points of the vertex on the connecting edge as second interpolation points corresponding to the vertex.

Operation S503: Perform sampling on the triangle associated with each vertex based on the second interpolation points corresponding to each vertex to obtain the sampling points corresponding to each vertex.

In this embodiment, after the triangle associated with each vertex is acquired, to better determine appropriate sampling points in the triangle associated with each vertex, the interpolation calculation may be performed on the opposite edge corresponding to each vertex on the triangle associated with each vertex in this embodiment, to acquire the first interpolation points of each vertex on the opposite edge, i.e., the first interpolation points corresponding to each vertex; for each vertex, the interpolation calculation is performed on the connecting edge between the vertex and each first interpolation point corresponding to the vertex to acquire the second interpolation points of each vertex on the connecting edge, i.e., the second interpolation points corresponding to each vertex; and then sampling is performed on the triangle associated with each vertex based on the second interpolation points corresponding to each vertex to acquire the sampling points corresponding to each vertex.

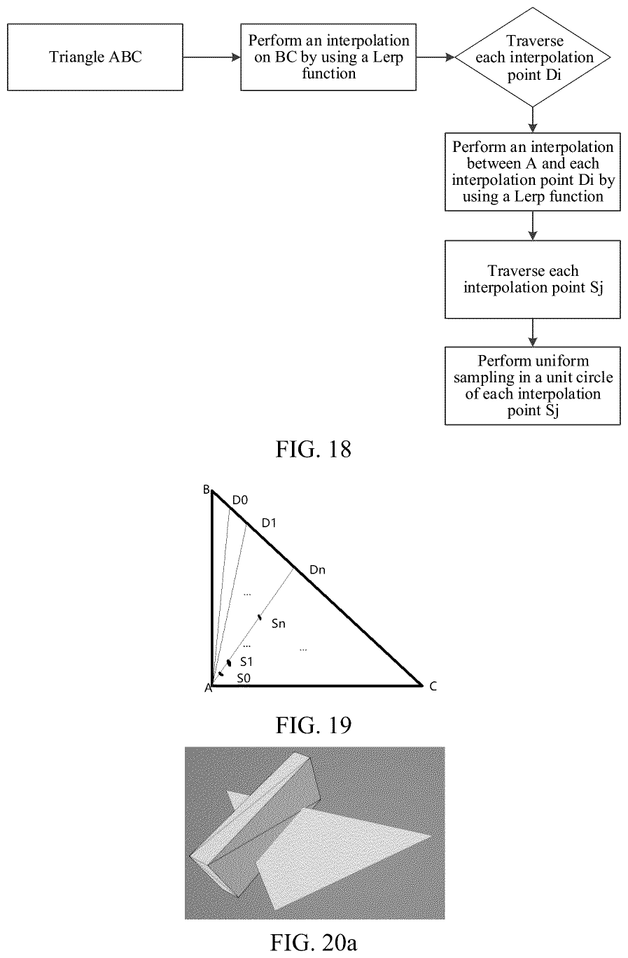

As shown in FIG. 19, the first interpolation points are a series of interpolation points Dᵢ (D₀, D₁, . . . , Dₙ, and the like shown in FIG. 19) obtained by performing an interpolation calculation on a connecting edge BC corresponding to a vertex A in a triangle associated with the vertex A. As shown in FIG. 18, the second interpolation points are a series of interpolation points Sⱼ (S₀, S₁, . . . , Sₙ, and the like shown in FIG. 19) obtained by performing an interpolation calculation on a connecting edge ADᵢ (a connecting edge ADₙ shown in FIG. 19) between the vertex A and each first interpolation point Dᵢ in the triangle associated with the vertex A.

Specifically, as shown in FIG. 18, assuming that an acquired triangle ABC is a surface of the triangular surface model, to solve an ambient occlusion value (i.e., an AO value) of the vertex A, sampling points may be uniformly generated on the triangle ABC in a uniform interpolation manner in this embodiment, or sampling points corresponding to each vertex may be acquired in another sampling manner, which is not specifically limited herein. In the uniform interpolation, an interpolation calculation may be specifically performed on the connecting edge BC corresponding to the vertex A by using a Lerp function to obtain a series of first interpolation points Dᵢ (D₀, D₁, . . . , Dₙ, and the like shown in FIG. 19), or another interpolation algorithm may be used. This is not specifically limited herein.

Further, as shown in FIG. 18, each first interpolation point Dᵢ (D₀, D₁, . . . , Dₙ, or the like shown in FIG. 19) may be traversed. On a connecting edge between the vertex A and each first interpolation point Dᵢ (D₀, D₁, . . . , Dₙ, or the like shown in FIG. 19), an interpolation calculation is performed by using a Lerp function to obtain a series of second interpolation points Sⱼ (S₀, S₁, . . . , Sₙ, and the like shown in FIG. 19), or another interpolation algorithm may be used. This is not specifically limited herein.

Further, as shown in FIG. 18, each second interpolation point Sⱼ (S₀, S₁, . . . , Sₙ, or the like shown in FIG. 19) may be traversed, and uniform sampling may be performed in a unit circle of each second interpolation point Sⱼ to obtain the sampling points of each vertex on the associated triangle.

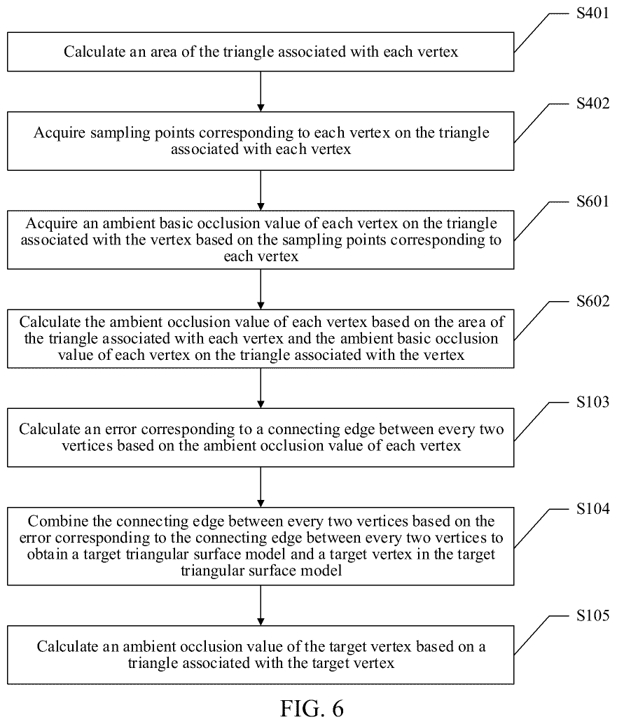

In some embodiments, based on the foregoing embodiment corresponding to FIG. 4, in another embodiment of a method for determining a vertex ambient occlusion value provided in embodiments of this disclosure, as shown in FIG. 6, Operation S403 of calculating the ambient occlusion value of each vertex based on the sampling points corresponding to each vertex and the area of the triangle associated with each vertex includes the following operations:

Operation S601: Acquire an ambient basic occlusion value of each vertex on the triangle associated with the vertex based on the sampling points corresponding to each vertex.

Operation S602: Calculate the ambient occlusion value of each vertex based on the area of the triangle associated with each vertex and the ambient basic occlusion value of each vertex on the triangle associated with the vertex.

In this embodiment, to calculate the ambient occlusion value of each vertex more accurately, after the sampling points corresponding to each vertex are acquired, the ambient basic occlusion value of each vertex on the triangle associated with the vertex may be acquired based on the sampling points corresponding to each vertex, and the ambient occlusion value of each vertex is further calculated based on the area of the triangle associated with each vertex and the ambient basic occlusion value of each vertex on the triangle associated with the vertex, so that the accuracy of the ambient occlusion value of each vertex can be improved to some extent.

The ambient basic occlusion value of each vertex is a probability obtained by performing summation and averaging on an occlusion probability corresponding to a light occlusion performed surrounding each sampling point, i.e., an occlusion factor.

Specifically, as shown in FIG. 16, after the sampling points corresponding to each vertex are acquired, an occlusion determination may be performed on a unit sphere of each sampling point by using a common AO calculation formula to acquire the occlusion probability corresponding to a light occlusion performed surrounding each sampling point, and a probability obtained by performing summation and averaging on the occlusion probability may be used as the ambient basic occlusion value of each vertex on the associated triangle. Further, as shown in FIG. 16, after the ambient basic occlusion value of each vertex on the triangle associated with the vertex is acquired, weighted averaging may be performed on the ambient basic occlusion value of each vertex on the triangle associated with the vertex with the area of the triangle associated with each vertex as a weight, to finally acquire the ambient occlusion value of each vertex, so that the acquired ambient occlusion value of each vertex can be smoother.

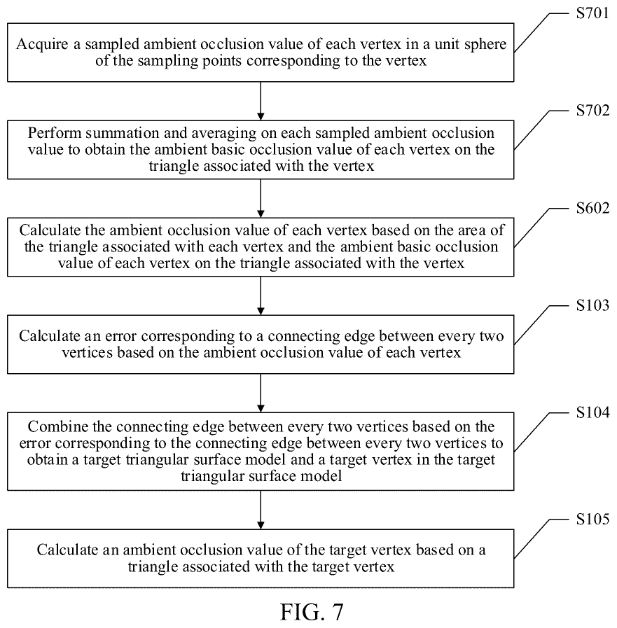

In some embodiments, based on the foregoing embodiment corresponding to FIG. 6, in another embodiment of a method for determining a vertex ambient occlusion value provided in embodiments of this disclosure, as shown in FIG. 7, Operation S601 of acquiring an ambient basic occlusion value of each vertex on the triangle associated with the vertex based on the sampling points corresponding to each vertex includes the following operations:

Operation S701: Acquire a sampled ambient occlusion value of each vertex in a unit sphere of the sampling points corresponding to the vertex.

Operation S702: Perform summation and averaging on each sampled ambient occlusion value to obtain the ambient basic occlusion value of each vertex on the triangle associated with the vertex.

In this embodiment, to calculate the ambient occlusion value of each vertex more accurately, after the sampling points corresponding to each vertex are acquired, based on the sampling points corresponding to each vertex, the sampled ambient occlusion value of each vertex in the unit sphere of the sampling points corresponding to the vertex is first acquired, then summation and averaging are performed on each acquired sampled ambient occlusion value to acquire the ambient basic occlusion value of the vertex on the triangle associated with the vertex, and subsequently the ambient occlusion value of each vertex may be further calculated based on the area of the triangle associated with each vertex and the ambient basic occlusion value of each vertex on the associated triangle, so that the accuracy of the ambient occlusion value of each vertex can be improved to some extent.

The sampled ambient occlusion value is the occlusion probability corresponding to a light occlusion performed surrounding each sampling point.

Specifically, as shown in FIG. 16, after the sampling points corresponding to each vertex are acquired, the sampled ambient occlusion value of each vertex in the unit sphere of the sampling points corresponding to the vertex may be first acquired by using a common AO calculation formula. Specifically, a normal vector corresponding to a geometric voxel (triangular surface model) outside sampling points P, a hemispherical space corresponding to each sampling point P, and a direction vector of emission of the hemisphere from each sampling point P are respectively substituted into corresponding visibility functions to perform integration, and the integration may be discretized (for example, by using the transform of Monte Carlo integration), to acquire the sampled ambient occlusion value of each vertex in the unit sphere of the sampling points corresponding to the vertex. Further, summation and averaging are performed on each sampled ambient occlusion value to acquire the ambient basic occlusion value of each vertex on the associated triangle.

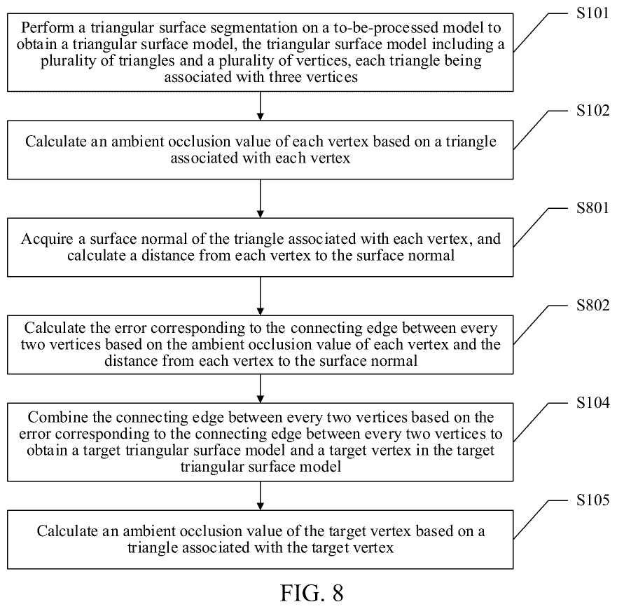

In some embodiments, based on the foregoing embodiment corresponding to FIG. 2, in another embodiment of a method for determining a vertex ambient occlusion value provided in embodiments of this disclosure, as shown in FIG. 8, Operation S103 of calculating an error corresponding to a connecting edge between every two vertices based on the ambient occlusion value of each vertex includes the following operations:

Operation S801: Acquire a surface normal of the triangle associated with each vertex, and calculate a distance from each vertex to the surface normal.

Operation S802: Calculate the error corresponding to the connecting edge between every two vertices based on the ambient occlusion value of each vertex and the distance from each vertex to the surface normal.

In this embodiment, after the ambient occlusion value of each vertex is acquired, the distance from each vertex to the surface normal may be calculated by acquiring the surface normal of the triangle associated with each vertex, and then the error corresponding to the connecting edge between every two vertices may be calculated based on the ambient occlusion value of each vertex and the distance from each vertex to the surface normal, to acquire a cost during the combination of each connecting edge, so that a redundant segmented triangular surface can be combined more accurately, and it is ensured that a valuable triangular surface can be kept.

Specifically, after the ambient occlusion value of each vertex is acquired, a triangular surface segmentation and rendering may be performed on the to-be-processed model according to the foregoing Mesh component in Unity, and the surface normal of the triangle associated with each vertex in the triangular surface model (the triangular surface model shown in FIG. 20b) is acquired by using the following Formula (1):

$$n = ( {p}_{2} - {p}_{1} ) \times ( {p}_{3} - {p}_{1} ) / ‖ ( {p}_{2} - {p}_{1} ) \times ( {p}_{3} - {p}_{1} ) ‖ , \qquad ( 1 )$$

where p₁, p₂, and p₃ are respectively configured for representing vertex coordinates of three vertices on a triangle f; and n represents a surface normal of the triangle f.

Further, the distance from each vertex to the surface normal may be calculated by using the following Formula (2):

$$d = - {n}^{T} p , \qquad ( 2 )$$

where n represents the surface normal of the triangle f, and p represents vertex coordinates of one vertex on the triangle f. d represents a distance from a vertex p to the surface normal n.

Further, the error corresponding to the connecting edge between every two vertices may be calculated based on the ambient occlusion value of each vertex and the distance from each vertex to the surface normal. Specifically, the error may be calculated by using a quadratic error function shown in the following Formula (3):

$${Q}^{f} ( v = ( \begin{matrix}p \\ s\end{matrix} ) ) = {Q}_{p}^{f} ( v ) + {\sum }_{k = 1}^{m} {Q}_{{s}_{k}}^{f} ( v ) , \qquad ( 3 )$$

where f represents a triangle associated with a vertex v, a vector p represents a vertex on the triangular surface model, and a vector s represents an attribute of the vertex, i.e., an ambient occlusion value attribute of each vertex. Therefore, m=1.

Qₚ^{f} may be specifically represented as the following Formula (4):

$${Q}_{p}^{f} = ( A , b , c ) = ( ( \begin{matrix}{nn}^{T} & ⋱0⋱ \\ ⋱0⋱ & ⋱0⋱\end{matrix} ) , ( \frac{dn}{0} ) , {d}^{2} ) , \qquad ( 4 )$$

where n represents the surface normal of the triangle f, and p represents vertex coordinates of one vertex on the triangle f. d represents the distance from the vertex p to the surface normal n, and may be respectively acquired by using the foregoing Formulas (1) and (2).

Qₛ_{ₛ}^{f} may be specifically represented as the following Formula (5):

$${Q}_{{s}_{k}}^{f} ( v ) = {( ( p ) - {s}_{k} )}^{2} = {( {g}_{k}^{T} p + {d}_{k} - {s}_{k} )}^{2} , \qquad ( 5 )$$

where [symbol] (p)=gₖ^{T}p+dₖ, sₖ is configured for representing an ambient occlusion value of the vertex v, gₓ represents a gradient of the triangle associated with the vertex v, and dₖ represents a distance from the vertex v to a surface normal of the associated triangle.

gₖ and dₖ may be solved by using the following Formula (6):

$$( \begin{matrix}{p}_{1}^{T} & 1 \\ {p}_{2}^{T} & 1 \\ {p}_{3}^{T} & 1 \\ {n}^{T} & 0\end{matrix} ) ( \begin{matrix}{g}_{k} \\ {d}_{k}\end{matrix} ) = ( \begin{matrix}{s}_{1 , k} \\ {s}_{2 , k} \\ {s}_{3 , k} \\ 0\end{matrix} ) , \qquad ( 6 )$$

where p represents vertex coordinates of one vertex on the triangle f, and a vector s represents an attribute of the vertex, i.e., an ambient occlusion value attribute of each vertex.

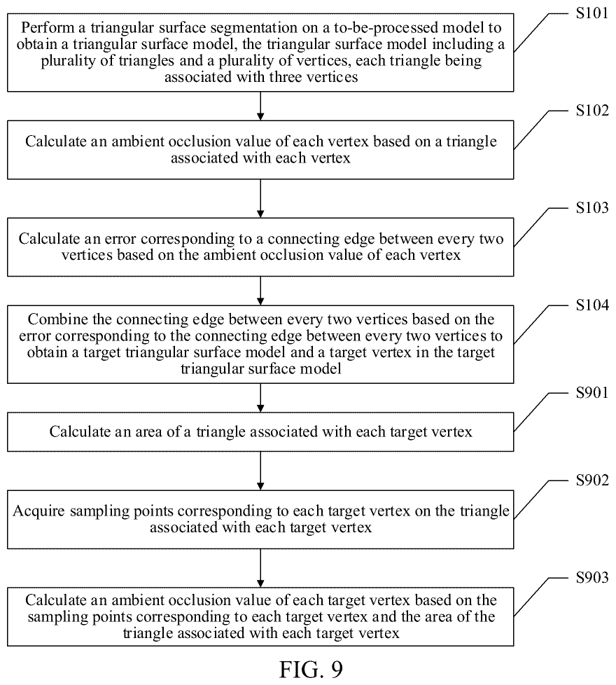

In some embodiments, based on the foregoing embodiment corresponding to FIG. 2, in another embodiment of a method for determining a vertex ambient occlusion value provided in embodiments of this disclosure, as shown in FIG. 9, Operation S105 of calculating an ambient occlusion value of the target vertex based on a triangle associated with the target vertex includes the following operations:

Operation S901: Calculate an area of a triangle associated with each target vertex.

Operation S902: Acquire sampling points corresponding to each target vertex on the triangle associated with each target vertex.

Operation S903: Calculate an ambient occlusion value of each target vertex based on the sampling points corresponding to each target vertex and the area of the triangle associated with each target vertex.

In this embodiment, after the target triangular surface model is acquired, the area of the triangle associated with each target vertex may be first calculated, sampling points corresponding to each target vertex on the triangle associated with each target vertex are acquired, and then the ambient occlusion value of each target vertex may be calculated based on the sampling points corresponding to each target vertex and the area of the triangle associated with each target vertex. Through the generated sampling points, a case that all outgoing light from the sampling points corresponding to each target vertex is blocked by another object is better captured, so that the occlusion factor of each target vertex, i.e., the ambient occlusion value of each target vertex, is better calculated.

Specifically, as shown in FIG. 16, after the target vertex is acquired, the area of the triangle associated with each target vertex may be first calculated. Specifically, a triangular surface segmentation and rendering may be performed on the to-be-processed model according to the foregoing Mesh component in Unity, to acquire vertex coordinates of each target vertex and texture coordinates of each triangle in a target triangular surface model (a triangular surface model shown in FIG. 20c), and then the area of each triangle may be calculated based on the vertex coordinates of each target vertex and the texture coordinates of each triangle according to a common calculation formula of the area of a triangle, so that the area of the triangle associated with each target vertex may be acquired.

Further, the sampling points corresponding to each target vertex on the triangle associated with each target vertex are acquired. Specifically, an interpolation calculation may be performed on an opposite edge corresponding to each target vertex on the triangle associated with each target vertex to acquire third interpolation points of each target vertex on the opposite edge as third interpolation points corresponding to the target vertex; then for each target vertex, an interpolation calculation is performed on a connecting edge between the target vertex and each third interpolation point corresponding to the target vertex to acquire fourth interpolation points of the target vertex on the connecting edge as fourth interpolation points corresponding to the target vertex; and then sampling is performed on the triangle associated with each target vertex based on the fourth interpolation points corresponding to each target vertex to acquire the sampling points corresponding to each target vertex.

Further, the ambient occlusion value of each target vertex may be calculated based on the sampling points corresponding to each target vertex and the area of the triangle associated with each target vertex. An occlusion determination may be performed on a unit sphere of each sampling point by using a common AO calculation formula to obtain an ambient occlusion value corresponding to each vertex surrounding each sampling point. After the ambient occlusion value of each target vertex on the associated triangle is acquired, weighted averaging may be performed on the ambient occlusion value of each target vertex on the associated triangle with the area of the triangle associated with each target vertex as a weight, to finally acquire the ambient occlusion value of each target vertex, so that the acquired ambient occlusion value of each target vertex can be smoother.

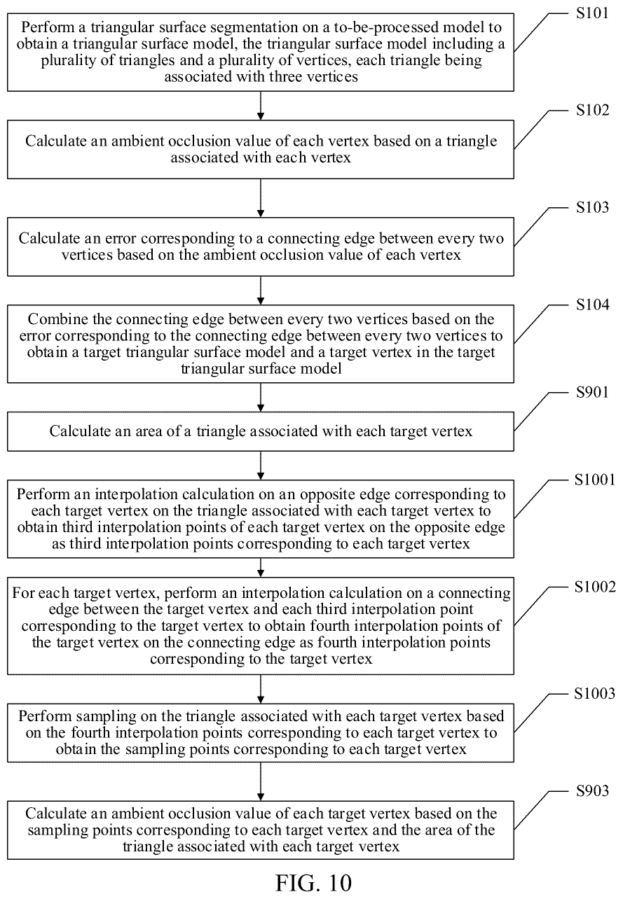

In some embodiments, based on the foregoing embodiment corresponding to FIG. 9, in another embodiment of a method for determining a vertex ambient occlusion value provided in embodiments of this disclosure, as shown in FIG. 10, Operation S902 of acquiring sampling points corresponding to each target vertex on the triangle associated with each target vertex includes the following operations:

Operation S1001: Perform an interpolation calculation on an opposite edge corresponding to each target vertex on the triangle associated with each target vertex to obtain third interpolation points of each target vertex on the opposite edge as third interpolation points corresponding to each target vertex.

Operation S1002: For each target vertex, perform an interpolation calculation on a connecting edge between the target vertex and each third interpolation point corresponding to the target vertex to obtain fourth interpolation points of the target vertex on the connecting edge as fourth interpolation points corresponding to the target vertex.

Operation S1003: Perform sampling on the triangle associated with each target vertex based on the fourth interpolation points corresponding to each target vertex to obtain the sampling points corresponding to each target vertex.

In this embodiment, after the triangle associated with each target vertex is acquired, to better generate appropriate sampling points in the triangle associated with each target vertex, the interpolation calculation may be performed on the opposite edge corresponding to each target vertex on the triangle associated with each target vertex in this embodiment, to acquire the third interpolation points of each target vertex on the opposite edge as the third interpolation points corresponding to each target vertex; for each target vertex, the interpolation calculation is performed on the connecting edge between the target vertex and each third interpolation point corresponding to the target vertex to acquire the fourth interpolation points of the target vertex on the connecting edge as the fourth interpolation points corresponding to the target vertex; and then sampling is performed on the triangle associated with each target vertex based on the fourth interpolation points corresponding to each target vertex to acquire the sampling points corresponding to each target vertex.

The third interpolation points are a series of interpolation points Dᵢ′ obtained by performing an interpolation calculation on a connecting edge B′C′ in a target triangle corresponding to a vertex A′ in the target triangle in the target triangular surface model associated with the vertex A′. The fourth interpolation points are a series of interpolation points Sⱼ′ obtained by performing an interpolation calculation on a connecting edge A′Dᵢ′ between the vertex A′ and each third interpolation point Dᵢ′ in the target triangle associated with the vertex A′.

Specifically, assuming that an acquired target triangle A′B′C′ is a triangular surface of the target triangular surface model, to solve an ambient occlusion value (i.e., an AO value) of the vertex A′, sampling points may be uniformly generated on the target triangle A′B′C′ in a uniform interpolation manner in this embodiment, or sampling points corresponding to each target vertex may be acquired in another sampling manner, which is not specifically limited herein. In the uniform interpolation, an interpolation calculation may be specifically performed on the connecting edge B′C′ corresponding to the vertex A′ by using a Lerp function to obtain a series of third interpolation points Dᵢ′, or another interpolation algorithm may be used. This is not specifically limited herein.

Further, each third interpolation point Dᵢ′ may be traversed. On the connecting edge between the vertex A′ and each third interpolation point Dᵢ′, a series of fourth interpolation points Sᵢ′ are obtained by performing an interpolation calculation by using a Lerp function, or another interpolation algorithm may be used. This is not specifically limited herein. Further, each fourth interpolation point Sᵢ′ may be traversed, and uniform sampling may be performed in a unit circle of each fourth interpolation point S′ to acquire the sampling points of each target vertex on the associated triangle.

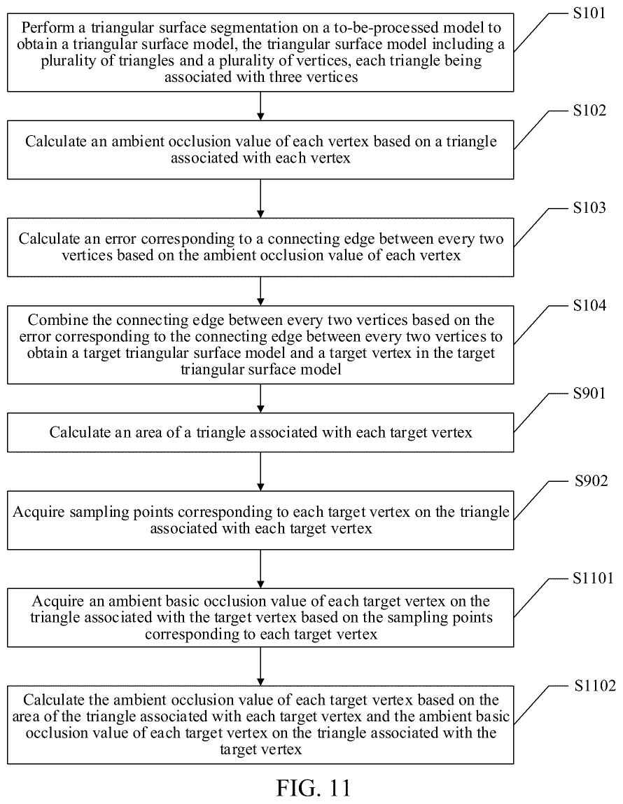

In some embodiments, based on the foregoing embodiment corresponding to FIG. 9, in another embodiment of a method for determining a vertex ambient occlusion value provided in embodiments of this disclosure, as shown in FIG. 11, Operation S903 of calculating an ambient occlusion value of each target vertex based on the sampling points corresponding to each target vertex and the area of the triangle associated with each target vertex includes the following operations:

Operation S1101: Acquire an ambient basic occlusion value of each target vertex on the triangle associated with the target vertex based on the sampling points corresponding to each target vertex.

Operation S1102: Calculate the ambient occlusion value of each target vertex based on the area of the triangle associated with each target vertex and the ambient basic occlusion value of each target vertex on the triangle associated with the target vertex.

In this embodiment, to calculate the ambient occlusion value of each target vertex more accurately, after the sampling points corresponding to each target vertex are acquired, the ambient basic occlusion value of each target vertex on the triangle associated with the target vertex may be acquired based on the sampling points corresponding to each target vertex, and the ambient occlusion value of each target vertex is further calculated based on the area of the triangle associated with each target vertex and the ambient basic occlusion value of each target vertex on the triangle associated with the target vertex, so that the accuracy of the ambient occlusion value of each target vertex can be improved to some extent.

The ambient basic occlusion value of each target vertex is a probability obtained by performing summation and averaging on an occlusion probability corresponding to a light occlusion performed surrounding each sampling point corresponding to each target vertex.

Specifically, after the sampling points corresponding to each target vertex are acquired, an occlusion determination may be performed on a unit sphere of each sampling point by using a common AO calculation formula to acquire the occlusion probability corresponding to a light occlusion performed surrounding each sampling point, and a probability obtained by performing summation and averaging is used as the ambient basic occlusion value of each target vertex on the associated triangle. Further, after the ambient basic occlusion value of each target vertex on the associated triangle is acquired, weighted averaging may be performed on the ambient basic occlusion value of each target vertex on the associated triangle with the area of the triangle associated with each target vertex as a weight, to finally acquire the ambient occlusion value of each target vertex, so that the acquired ambient occlusion value of each target vertex can be smoother.

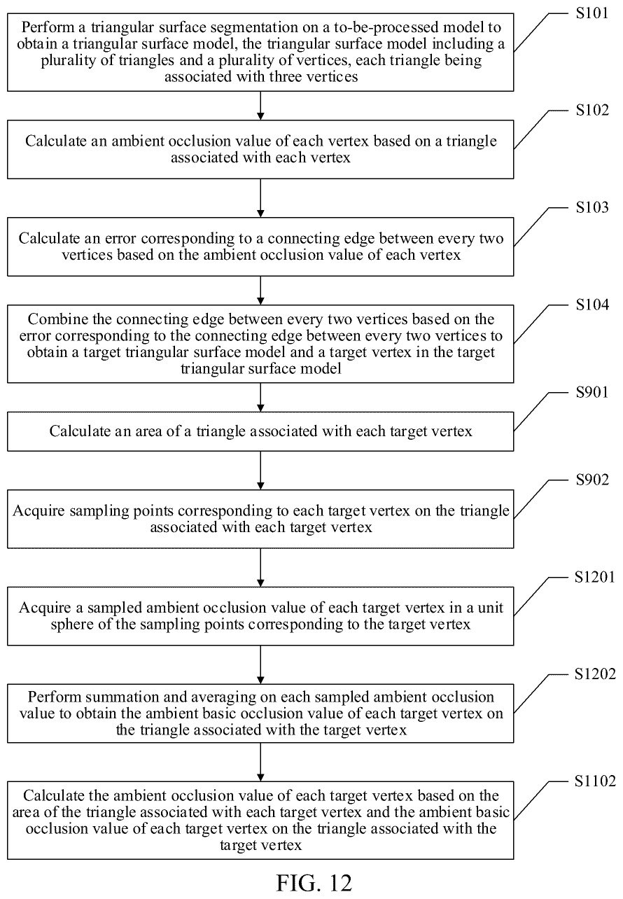

In some embodiments, based on the foregoing embodiment corresponding to FIG. 11, in another embodiment of a method for determining a vertex ambient occlusion value provided in embodiments of this disclosure, as shown in FIG. 12, Operation S1101 of acquiring an ambient basic occlusion value of each target vertex on the associated triangle based on the sampling points corresponding to each target vertex includes the following operations:

Operation S1201: Acquire a sampled ambient occlusion value of each target vertex in a unit sphere of the sampling points corresponding to the target vertex.

Operation S1202: Perform summation and averaging on each sampled ambient occlusion value to obtain the ambient basic occlusion value of each target vertex on the triangle associated with the target vertex.

In this embodiment, to calculate the ambient occlusion value of each target vertex more accurately, after the sampling points corresponding to each target vertex are acquired, based on the sampling points corresponding to each target vertex, the sampled ambient occlusion value of each target vertex in the unit sphere of the sampling points corresponding to the target vertex is acquired, then summation and averaging are performed on each acquired sampled ambient occlusion value to acquire the ambient basic occlusion value of each target vertex on the associated triangle, and subsequently the ambient occlusion value of each target vertex may be further calculated based on the area of the triangle associated with each target vertex and the ambient basic occlusion value of each target vertex on the associated triangle, so that the accuracy of the ambient occlusion value of each target vertex can be improved to some extent.

The sampled ambient occlusion value of each target vertex is an occlusion probability corresponding to a light occlusion performed surrounding each sampling point corresponding to each target vertex.

Specifically, after the sampling points corresponding to each target vertex are acquired, the sampled ambient occlusion value of each target vertex in the unit sphere of the sampling points corresponding to the target vertex may be first acquired by using a common AO calculation formula. Specifically, a normal vector corresponding to a geometric voxel (triangular surface model) outside sampling points P, a hemispherical space corresponding to each sampling point P, and a direction vector of emission of the hemisphere from each sampling point P are respectively substituted into corresponding visibility functions to perform integration, and the integration may be discretized (for example, by using the transform of Monte Carlo integration), to acquire the sampled ambient occlusion value of each target vertex in the unit sphere of each sampling point. Further, summation and averaging are performed on each sampled ambient occlusion value to acquire the ambient basic occlusion value of each target vertex on the associated triangle.

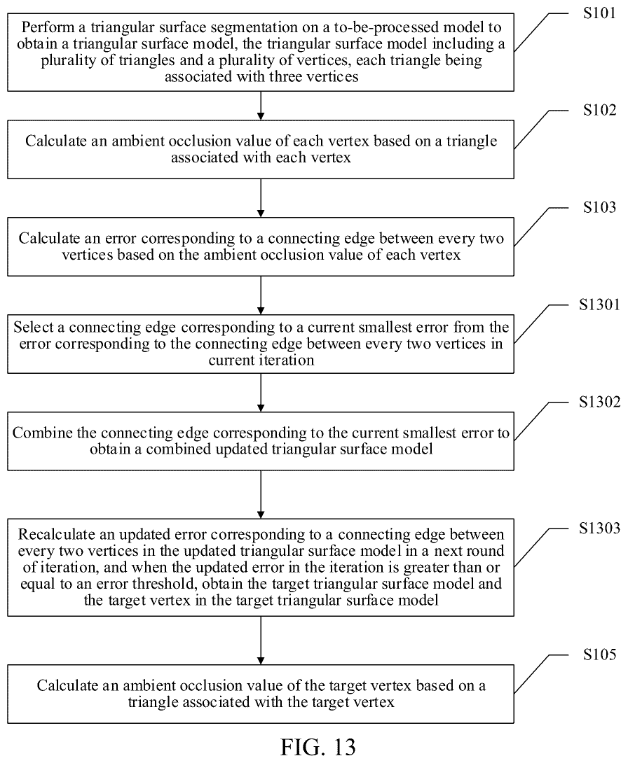

In some embodiments, based on the foregoing embodiment corresponding to FIG. 2, in another embodiment of a method for determining a vertex ambient occlusion value provided in embodiments of this disclosure, as shown in FIG. 13, Operation S104 of combining the connecting edge between every two vertices based on the error corresponding to the connecting edge between every two vertices to obtain a target triangular surface model and a target vertex in the target triangular surface model includes the following operations:

Operation S1301: Select a connecting edge corresponding to a current smallest error from the error corresponding to the connecting edge between every two vertices in current iteration.

Operation S1302: Combine the connecting edge corresponding to the current smallest error to obtain a combined updated triangular surface model.

Operation S1303: Recalculate an updated error corresponding to a connecting edge between every two vertices in the updated triangular surface model in a next round of iteration, and when the updated error in the iteration is greater than or equal to an error threshold, obtain the target triangular surface model and the target vertex in the target triangular surface model.

In this embodiment, after the error corresponding to the connecting edge between every two vertices is acquired, the connecting edge corresponding to the current smallest error may be selected from the error corresponding to the connecting edge between every two vertices in the current iteration, and the connecting edge corresponding to the current smallest error is combined to acquire the combined updated triangular surface model. The updated error corresponding to the connecting edge between every two vertices in the updated triangular surface model is then recalculated in the next round of iteration, and when the updated error in the iteration is greater than or equal to the error threshold, the connecting edge is combined, and the iteration ends, to acquire the target triangular surface model and the target vertex in the target triangular surface model. Through the updated error, a redundant segmented triangular surface is combined, so that a valuable triangular surface can be kept more accurately, and the target triangular surface model and the target vertex are acquired in a better and faster manner, thereby reducing operational costs to some extent.

Specifically, as shown in FIG. 17, after the error corresponding to the connecting edge between every two vertices is acquired, in a current round of iteration, the error corresponding to the connecting edge between every two vertices in the current iteration may be compared two by two, to select the connecting edge corresponding to the current smallest error, and further, the connecting edge corresponding to the current smallest error may be combined to acquire a combined updated triangular surface model. Specifically, the connecting edge between two vertices may be eliminated. If an isolated vertex that is not connected by a connecting edge appears in a process of eliminating connecting edges, the isolated vertex may be eliminated, to implement the combination of the connecting edge corresponding to the smallest error.

Further, the updated error corresponding to the connecting edge between every two vertices in the updated triangular surface model may be recalculated in a next round of iteration, and the iteration ends when the updated error in the iteration is greater than or equal to the error threshold, to acquire the target triangular surface model (a target triangular surface model shown in FIG. 20c) and the target vertex (a vertex in the target triangular surface model shown in FIG. 20c) in the target triangular surface model.

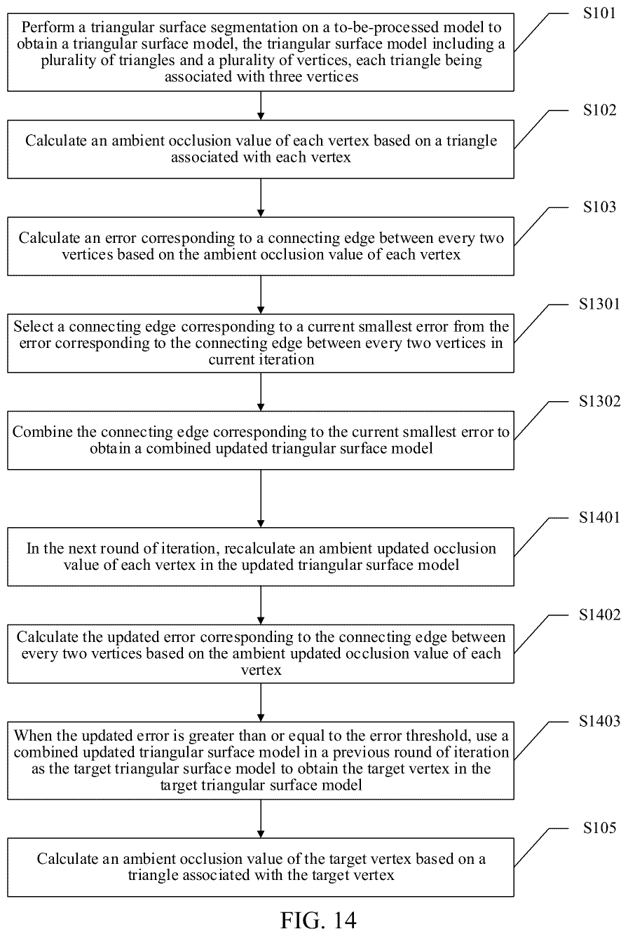

In some embodiments, based on the foregoing embodiment corresponding to FIG. 13, in another embodiment of a method for determining a vertex ambient occlusion value provided in embodiments of this disclosure, as shown in FIG. 14, Operation S1303 of recalculating an updated error corresponding to a connecting edge between every two vertices in the updated triangular surface model in a next round of iteration, and when the updated error in the iteration is greater than or equal to an error threshold, obtain the target triangular surface model and the target vertex in the target triangular surface model includes the following operations:

Operation S1401: In the next round of iteration, recalculate an ambient updated occlusion value of each vertex in the updated triangular surface model.

Operation S1402: Calculate the updated error corresponding to the connecting edge between every two vertices based on the ambient updated occlusion value of each vertex.

Operation S1403: When the updated error is greater than or equal to the error threshold, use a combined updated triangular surface model in a previous round of iteration as the target triangular surface model to obtain the target vertex in the target triangular surface model.

In this embodiment, after the combined updated triangular surface model in the current iteration is acquired, in the next round of iteration, the ambient updated occlusion value of each vertex in the updated triangular surface model may be recalculated, and the updated error corresponding to the connecting edge between every two vertices is calculated based on the ambient updated occlusion value of each vertex. If the smallest updated error in the current iteration is greater than or equal to the error threshold, the combined updated triangular surface model in the previous round of iteration may be used as the target triangular surface model to obtain the target vertex in the target triangular surface model. In this manner, the cost, i.e., the error, of combining each edge can be calculated, an edge with the smallest error in all edges can be selected for combination in each time of iteration, and a redundant segmented triangular surface can be combined through the updated error, so that a valuable triangular surface can be kept more accurately, and the target triangular surface model and the target vertex are better acquired.

Specifically, as shown in FIG. 17, after the combined updated triangular surface model in the current iteration is acquired, in the next round of iteration, the ambient updated occlusion value of each vertex in the updated triangular surface model may be recalculated. Specifically, the foregoing occlusion factor algorithm may continue to be used to calculate one occlusion factor, i.e., a current ambient updated occlusion value of each vertex in the updated triangular surface model, for each vertex based on the triangle associated with each vertex in the updated triangular surface model.

Further, after the ambient updated occlusion value of each vertex in the updated triangular surface model is acquired, the updated error corresponding to the connecting edge between every two vertices may be calculated based on the ambient updated occlusion value of each vertex. Specifically, the surface normal of the triangle associated with each vertex in the updated triangular surface model may be acquired, a distance from each vertex in the updated triangular surface model to the surface normal is calculated, and then the updated error corresponding to the connecting edge between every two vertices may be calculated based on the ambient occlusion value of each vertex and the distance from each vertex to the surface normal.

Further, the connecting edge between every two vertices in the updated triangular surface model may be combined based on the updated error, to obtain the combined triangular surface model. Similarly, in a further next round of iteration, the foregoing operation of recalculating the ambient updated occlusion value of each vertex in the updated triangular surface model and calculating the updated error to update the triangular surface model and update the ambient updated occlusion value of each vertex may continue to be performed, and when the smallest updated error in the iteration is greater than or equal to the error threshold, the iteration of combining the connecting edge ends. Therefore, the updated triangular surface model obtained through the combination in the previous round of iteration may be used as the target triangular surface model to obtain the target vertex in the target triangular surface model.

After the updated triangular surface model obtained through combination in the previous round of iteration is used as the target triangular surface model and the target vertex in the target triangular surface model is obtained, an ambient occlusion value corresponding to a vertex in the updated triangular surface model obtained through combination in the previous round of iteration may be directly used as the ambient occlusion value of the target vertex. To acquire the ambient occlusion value of the target vertex more accurately, after the target vertex is acquired, the area of the triangle associated with each target vertex may be recalculated, sampling points corresponding to each target vertex on the triangle associated with each target vertex are acquired, and then the ambient occlusion value of each target vertex is calculated based on the sampling points corresponding to each target vertex and the area of the triangle associated with each target vertex.

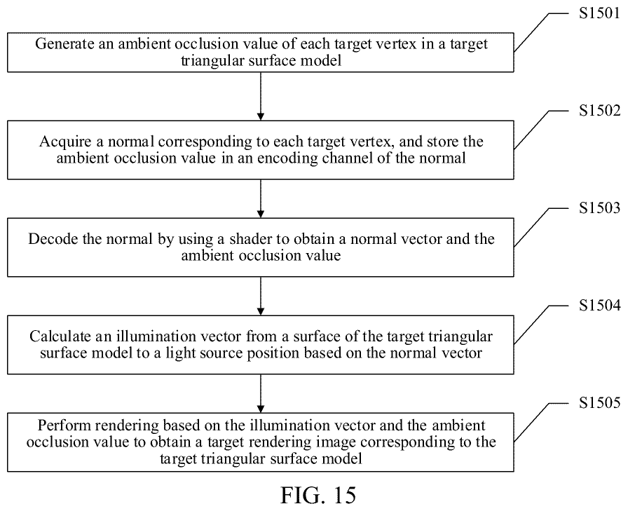

A method for applying a vertex ambient occlusion value in this disclosure is described below. Referring to FIG. 15, an embodiment of a method for applying a vertex ambient occlusion value in an embodiment of this disclosure includes the following operations:

Operation S1501: Generate an ambient occlusion value of each target vertex in a target triangular surface model by using the foregoing method.

Operation S1502: Acquire a normal corresponding to each target vertex, and store the ambient occlusion value in an encoding channel of the normal.

Operation S1503: Decode the normal by using a shader to obtain a normal vector and the ambient occlusion value.

Operation S1504: Calculate an illumination vector from a surface of the target triangular surface model to a light source position based on the normal vector.

Operation S1505: Perform rendering based on the illumination vector and the ambient occlusion value to obtain a target rendering image corresponding to the target triangular surface model.

In this embodiment, the normal is a vector perpendicular to a tangent plane, and is a vector perpendicular to a mesh at a given vertex. Each vertex has one normal, one normal is one three-dimensional vector, and one three-dimensional vector is formed by three components: an X component, a Y component, and a Z component. The information may be stored through a normal channel. The normal channel is configured for storing normal vector information and has four channels (x, y, z, w).

The shader includes a vertex shader and a fragment shader.

Specifically, in an actual application scenario (for example, a game scenario, or a virtual film production scenario), an object that needs to be rendered (the to-be-processed model shown in FIG. 20a) is prepared, and a CPU reads model data (for example, an .obj file stores model vertex information, model UV information, model vertex index information, and a rendering status (for example, material, texture, and a shader)) and transfers the model data to a GPU. Specifically, an ambient occlusion value of each target vertex in the target triangular surface model (the target triangular surface model shown in FIG. 20c, or the like) corresponding to the object that needs to be rendered (the to-be-processed model shown in FIG. 20a, or the like) may be first generated by using the foregoing method.

The ambient occlusion value is a floating-point number. Therefore, when more self-occlusions exist, the ambient occlusion value further approximates to 0, or otherwise further approximates to 1.0. A normal usually has only three dimensions. Therefore, the normal only occupies three channels (xyz) of float4, and one w channel is left. The ambient occlusion value of the vertex exactly occupies only one float.

Therefore, the normal corresponding to each target vertex may be acquired, and the ambient occlusion value may be stored in the encoding channel of the normal. Specifically, in the logic corresponding to the CPU, the vertex ambient occlusion value is stored in the w channel of the normal in a manner of a logic sentence “FVertexFactoryInput.TangentX.W=the VertexAO value”. Next, related data such as FVertexFactoryInput may be uploaded to the GPU end by using an API command of the GPU.

Further, after the GPU end receives data such as FVertexFactory Input, a geometric stage may be first entered. Specifically, the vertex shader may be executed once when each piece of vertex data is inputted. First, a float4 form of, for example, four floats, i.e., four channels, is usually used for variables in the vertex shader. Each corresponding channel may usually be indexed by using rgba or xyzw. Therefore, the vertex ambient occlusion value stored in the w channel of the normal may be defined in a manner of defining vertex data structure (for example, MobileBasePass VertexShader in UE4) for case of subsequent indexing, so that additional memory overheads do not need to be generated, and nearly zero overheads are required for indexing of the vertex ambient occlusion value. In addition, subsequently, the vertex shader may transfer the data of the vertex ambient occlusion value to the fragment shader, i.e., a pixel shader, so that the pixel shader can directly read the ambient occlusion value for subsequent rendering. Next, the vertex shader may convert vertex coordinates from a model space into a homogeneous clipping space, and in addition, operations such as perspective projection, vertex illumination, a texture calculation, and skinning are also performed in this stage.

Further, all diagram elements (triangles, line segments, and points) represented by the homogeneous clipping space may be processed by using a geometric shader. Further, because an actual scene may be very large, a picture outside the field of view of a camera does not require a rendering calculation, diagram elements outside the field of view may be eliminated through clipping, i.e., points that do not require rendering are eliminated through clipping. Next, screen mapping may be performed on diagram elements after clipping. Specifically, x and y coordinates of the diagram elements may be converted into a screen coordinate system to acquire normalized device coordinates. The range of device coordinates of Unity is also in [−1, 1] like that of OpenGL.

Further, after the geometric stage ends, a rasterization stage of converting the coordinates in the screen coordinate system into image pixels may be entered, and data is received by the fragment shader, i.e., the pixel shader. First, a normal may be decoded in the pixel shader (for example, MobileBasePassPixelShader of UE4), to acquire a normal vector (for example, color values in xyz channels) and ambient occlusion values (for example, AOs stored in the w channel, for example, AO1 is 0.65354, AO2 is 0.48031, . . . , and AOn is 0.74803), and screen coordinates, depth information, texture information, or other information may be further read.

Further, the illumination vector from the surface of the target triangular surface model to the light source position is calculated based on the normal vector. Specifically, the normal vector may be first converted into a coordinate system of a tangent space, and an illumination calculation may be performed in the tangent space to acquire the illumination vector. Next, rendering may be performed based on the illumination vector and the ambient occlusion value (a plurality of AO values between 0 and 1, to be specific, AOs are not all 1) to obtain the target rendering image (an image with clear shading shown in FIG. 21b) corresponding to the target triangular surface model.

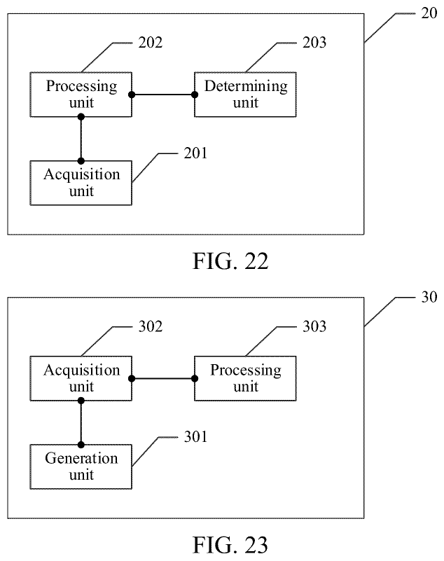

An apparatus for determining a vertex ambient occlusion value in this disclosure is described below in detail. FIG. 22 is a schematic diagram of an embodiment of an apparatus for determining a vertex ambient occlusion value in an embodiment of this disclosure. The apparatus 20 for determining a vertex ambient occlusion value includes:

an acquisition unit 201, configured to perform a triangular surface segmentation on a to-be-processed model to obtain a triangular surface model, the triangular surface model including a plurality of triangles and a plurality of vertices, each triangle being associated with three vertices;

a processing unit 202, configured to calculate an ambient occlusion value of each vertex based on a triangle associated with each vertex;

the processing unit 202 being further configured to calculate an error corresponding to a connecting edge between every two vertices based on the ambient occlusion value of each vertex;

the processing unit 202 being further configured to combine the connecting edge between every two vertices based on the error corresponding to the connecting edge between every two vertices to obtain a target triangular surface model and a target vertex in the target triangular surface model; and

a determining unit 203, configured to calculate an ambient occlusion value of the target vertex based on a triangle associated with the target vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

group the vertices in the triangular surface model according to a normal orientation to obtain at least one vertex set, each vertex in the vertex set being at least associated with one triangle; and

calculate the ambient occlusion value of each vertex based on the triangle associated with each vertex in each vertex set.

In some embodiments, based on the foregoing embodiment corresponding to FIG. 22, in another embodiment of an apparatus for determining a vertex ambient occlusion value provided in embodiments of this disclosure, the processing unit 202 may be further configured to:

calculate an area of the triangle associated with each vertex;

acquire sampling points corresponding to each vertex on the triangle associated with each vertex; and

calculate the ambient occlusion value of each vertex based on the sampling points corresponding to each vertex and the area of the triangle associated with each vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

perform an interpolation calculation on an opposite edge corresponding to each vertex on the triangle associated with each vertex to obtain first interpolation points of each vertex on the opposite edge as first interpolation points corresponding to each vertex;

for each vertex, perform an interpolation calculation on a connecting edge between the vertex and each first interpolation point corresponding to the vertex to obtain second interpolation points of the vertex on the connecting edge as second interpolation points corresponding to the vertex; and

perform sampling on the triangle associated with each vertex based on the second interpolation points corresponding to each vertex to obtain the sampling points corresponding to each vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

acquire an ambient basic occlusion value of each vertex on the triangle associated with the vertex based on the sampling points corresponding to each vertex; and

calculate the ambient occlusion value of each vertex based on the area of the triangle associated with each vertex and the ambient basic occlusion value of each vertex on the triangle associated with the vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

acquire a sampled ambient occlusion value of each vertex in a unit sphere of the sampling points corresponding to the vertex; and

perform summation and averaging on each sampled ambient occlusion value to obtain the ambient basic occlusion value of each vertex on the triangle associated with the vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

acquire a surface normal of the triangle associated with each vertex, and calculate a distance from each vertex to the surface normal; and

calculate the error corresponding to the connecting edge between every two vertices based on the ambient occlusion value of each vertex and the distance from each vertex to the surface normal.

In some embodiments, based on the foregoing embodiment corresponding to FIG. 22, in another embodiment of an apparatus for determining a vertex ambient occlusion value provided in embodiments of this disclosure, the determining unit 203 may be further configured to:

calculate an area of a triangle associated with each target vertex;

acquire sampling points corresponding to each target vertex on the triangle associated with each target vertex; and

calculate an ambient occlusion value of each target vertex based on the sampling points corresponding to each target vertex and the area of the triangle associated with each target vertex.

In some embodiments, based on the foregoing embodiment corresponding to FIG. 22, in another embodiment of an apparatus for determining a vertex ambient occlusion value provided in embodiments of this disclosure, the determining unit 203 may be further configured to:

perform an interpolation calculation on an opposite edge corresponding to each target vertex on the triangle associated with each target vertex to obtain third interpolation points of each target vertex on the opposite edge as third interpolation points corresponding to each target vertex;

for each target vertex, perform an interpolation calculation on a connecting edge between the target vertex and each third interpolation point corresponding to the target vertex to obtain fourth interpolation points of the target vertex on the connecting edge as fourth interpolation points corresponding to the target vertex; and

perform sampling on the triangle associated with each target vertex based on the fourth interpolation points corresponding to each target vertex to obtain the sampling points corresponding to each target vertex.

In some embodiments, based on the foregoing embodiment corresponding to FIG. 22, in another embodiment of an apparatus for determining a vertex ambient occlusion value provided in embodiments of this disclosure, the determining unit 203 may be further configured to:

acquire an ambient basic occlusion value of each target vertex on the triangle associated with the target vertex based on the sampling points corresponding to each target vertex; and

calculate the ambient occlusion value of each target vertex based on the area of the triangle associated with each target vertex and the ambient basic occlusion value of each target vertex on the triangle associated with the target vertex.

In some embodiments, based on the foregoing embodiment corresponding to FIG. 22, in another embodiment of an apparatus for determining a vertex ambient occlusion value provided in embodiments of this disclosure, the determining unit 203 may be further configured to:

acquire a sampled ambient occlusion value of each target vertex in a unit sphere of the sampling points corresponding to the target vertex; and

perform summation and averaging on each sampled ambient occlusion value to obtain the ambient basic occlusion value of each target vertex on the triangle associated with the target vertex.

In some embodiments, based on the foregoing embodiment corresponding to FIG. 22, in another embodiment of an apparatus for determining a vertex ambient occlusion value provided in embodiments of this disclosure, the processing unit 202 may be further configured to:

select a connecting edge corresponding to a current smallest error from the error corresponding to the connecting edge between every two vertices in current iteration;

combine the connecting edge corresponding to the current smallest error to obtain a combined updated triangular surface model; and

recalculate an updated error corresponding to a connecting edge between every two vertices in the updated triangular surface model in a next round of iteration, and when the updated error in the iteration is greater than or equal to an error threshold, obtain the target triangular surface model and the target vertex in the target triangular surface model.

In some embodiments, based on the foregoing embodiment corresponding to FIG. 22, in another embodiment of an apparatus for determining a vertex ambient occlusion value provided in embodiments of this disclosure, the processing unit 202 may be further configured to:

in the next round of iteration, recalculate an ambient updated occlusion value of each vertex in the updated triangular surface model;

calculate the updated error corresponding to the connecting edge between every two vertices based on the ambient updated occlusion value of each vertex; and

when the updated error is greater than or equal to the error threshold, use a combined updated triangular surface model in a previous round of iteration as the target triangular surface model to obtain the target vertex in the target triangular surface model.

An apparatus for applying a vertex ambient occlusion value in this disclosure is described below in detail. FIG. 23 is a schematic diagram of an embodiment of an apparatus for applying a vertex ambient occlusion value in an embodiment of this disclosure. The apparatus 30 for applying a vertex ambient occlusion value includes:

a generation unit 301, configured to generate an ambient occlusion value of each target vertex in a target triangular surface model;

an acquisition unit 302, configured to: acquire a normal corresponding to each target vertex, and store the ambient occlusion value in an encoding channel of the normal;

a processing unit 303, configured to decode the normal by using a shader to obtain a normal vector and the ambient occlusion value;

the acquisition unit 302 being further configured to calculate an illumination vector from a surface of the target triangular surface model to a light source position based on the normal vector; and

the processing unit 303 being further configured to perform rendering based on the illumination vector and the ambient occlusion value to obtain a target rendering image corresponding to the target triangular surface model.

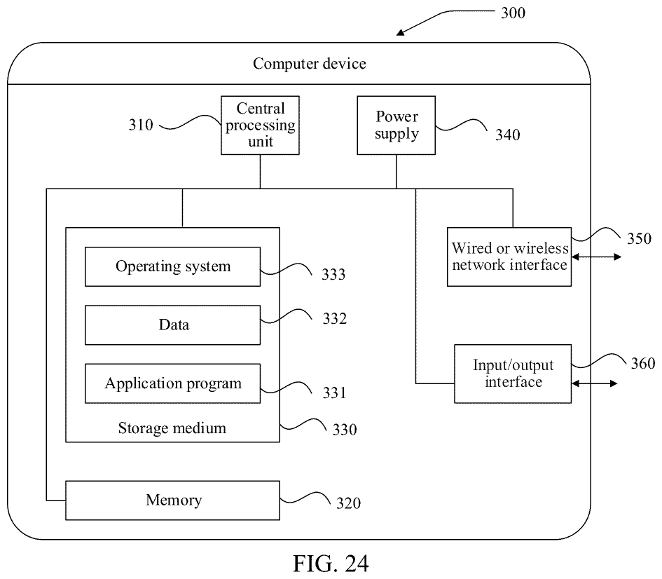

Another aspect of this disclosure provides a schematic diagram of another computer device. FIG. 24 is a schematic structural diagram of a computer device according to an embodiment of this disclosure. The computer device 300 may vary greatly due to different configurations or performance, and may include one or more central processing units (CPU) 310 (for example, one or more processors, processing circuitry, and the like) and a memory 320, and one or more storage medium 330 (for example, one or more mass storage devices) that store application programs 331 or data 332. The memory 320 and the storage medium 330 may be transient or persistent storages. A program stored in the storage medium 330 may include one or more modules (not shown in the figure), and each module may include a series of instruction operations on the computer device 300. Furthermore, the CPUs 310 may be configured to communicate with the storage mediums 330, and perform, on the computer device 300, the series of instruction operations in the storage mediums 330.

The computer device 300 may further include one or more power supplies 340, one or more wired or wireless network interfaces 350, one or more input/output interfaces 360, and/or one or more operating systems 333, for example, Windows Server™, Mac OS X™, Unix™, Linux™, or FreeBSD™.

The foregoing computer device 300 may be further configured to perform the operations in the embodiments corresponding to FIG. 2 to FIG. 14 and the operations in the embodiment corresponding to FIG. 15.

Another aspect of this disclosure provides a computer-readable storage medium, having a computer program stored therein, the computer program, when executed by a processor (e.g., processing circuitry), implementing the operations in the method described in the embodiments shown in FIG. 2 to FIG. 14 and the operations in the embodiment corresponding to FIG. 15.

Another aspect of this disclosure provides a computer program product including a computer program, the computer program, when executed by a processor, implementing the operations in the method described in the embodiments shown in FIG. 2 to FIG. 14 and the operations in the embodiment corresponding to FIG. 15.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that for convenience and conciseness of description, for specific working processes of the foregoing systems, apparatuses and units, reference may be made to the corresponding processes in the foregoing method embodiments, and details are not described herein again.

In the several embodiments provided in this disclosure, the disclosed system, apparatus, and method may be implemented in other manners. For example, the apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of this disclosure may be integrated into one processing unit, or each of the units may exist alone physically, or two or more units may be integrated into one unit. The integrated unit may be implemented in the form of hardware, or may be implemented in the form of a software functional unit.

When the integrated unit is implemented in the form of a software functional unit and sold or used as an independent product, the integrated unit may be stored in a computer-readable storage medium (e.g., non-transitory computer readable storage medium). Based on such an understanding, the technical solutions of this disclosure essentially, or the part contributing to the related technology, or all or some of the technical solutions may be implemented in the form of a software product. The computer software product is stored in a storage medium and includes several instructions for instructing a computer device (which may be a personal computer, a server, a network device, or the like) to perform all or some of the operations of the methods described in the embodiments of this disclosure. The foregoing storage medium includes: any medium that can store program code, such as a USB flash drive, a removable hard disk, a ROM, a RAM, a magnetic disk, or an optical disc.

What is claimed is:

1. A method for determining a vertex ambient occlusion value,, comprising:
performing a triangular surface segmentation on a to-be-processed model to obtain a triangular surface model, the triangular surface model comprising a plurality of triangles and a plurality of vertices, each triangle being associated with three vertices that are connected by connecting edges;
calculating ambient occlusion values respectively of the plurality of vertices, a first ambient occlusion value of a first vertex being calculated based on first one or more triangles associated with the first vertex;
calculating errors respectively associated with a plurality of connecting edges based on the ambient occlusion values of the plurality of vertices; and
collapsing a first connecting edge between two vertices based on the errors to obtain a simplified triangular surface model.

2. The method according to claim 1, wherein the calculating the ambient occlusion values comprises:
grouping the plurality of vertices in the triangular surface model according to normal orientations of the plurality of triangles associated with the plurality of vertices to obtain at least a first vertex set, the first vertex set including first one or more vertices being at least associated with a first triangle; and
calculating an ambient occlusion value of a vertex in the first vertex set based on the first triangle associated with the vertex in the first vertex set.

3. The method according to claim 1, wherein the calculating the ambient occlusion values comprises:
calculating areas of the first one or more triangles associated with the first vertex;
acquiring sampling points in the first one or more triangles associated with the first vertex; and
calculating the first ambient occlusion value of the first vertex based on the sampling points in the first one or more triangles and the areas of the first one or more triangles.

4. The method according to claim 3, wherein the acquiring the sampling points comprises:
performing a first interpolation calculation on an opposite edge to the first vertex in a first triangle in the first one or more triangles to obtain first interpolation points of on the opposite edge;
performing second interpolation calculations on interconnecting edges between the first vertex and the first interpolation points to obtain second interpolation points; and
performing sampling on the first triangle based on the second interpolation points.

5. The method according to claim 3, wherein the calculating the first ambient occlusion value of the first vertex comprises:
acquiring ambient basic occlusion values of the first vertex respectively for the first one or more triangles based on the sampling points; and
calculating the first ambient occlusion value of the first vertex based on the areas of the first one or more triangles and the ambient basic occlusion values respectively for the first one or more triangles.

6. The method according to claim 5, wherein the acquiring the ambient basic occlusion values comprises:
acquiring sampled ambient occlusion values of the sampling points, a sampled ambient occlusion value of a sampling point being sampled as in a unit sphere of the sampling point; and
averaging first sampled ambient occlusion values in a first triangle to obtain a first ambient basic occlusion value of the first vertex on the first triangle.

7. The method according to claim 1, wherein the calculating the errors comprises:
acquiring surface normals of the plurality of triangles;
calculating distances from the plurality of vertices to the surface normals; and
calculating the errors associated with the connecting edges based on ambient occlusion values and the distances.

8. The method according to claim 1, wherein the collapsing the first connecting edge comprises:
selecting the first connecting edge that has a current smallest error from the errors in a current round of iteration; and
collapsing the first connecting edge to obtain the simplified triangular surface model that is an output of the current round of iteration and an input to a next round of iteration.

9. The method according to claim 8, further comprising:
recalculating updated errors of updated connecting edges in the simplified triangular surface model in the next round of iteration; and
when the updated errors in the next round of iteration are greater than or equal to an error threshold, determining the simplified triangular surface model that is output from the current round of iteration to be a target triangular surface model to be used for rendering.

10. An apparatus, comprising processing circuitry configured to:
perform a triangular surface segmentation on a to-be-processed model to obtain a triangular surface model, the triangular surface model comprising a plurality of triangles and a plurality of vertices, each triangle being associated with three vertices that are connected by connecting edges;
calculate ambient occlusion values respectively of the plurality of vertices, a first ambient occlusion value of a first vertex being calculated based on first one or more triangles associated with the first vertex;
calculate errors respectively associated with a plurality of connecting edges based on the ambient occlusion values of the plurality of vertices; and
collapse a first connecting edge between two vertices based on the errors to obtain a simplified triangular surface model.

11. The apparatus according to claim 10, wherein the processing circuitry is configured to:
group the plurality of vertices in the triangular surface model according to normal orientations of the plurality of triangles associated with the plurality of vertices to obtain at least a first vertex set, the first vertex set including first one or more vertices being at least associated with a first triangle; and
calculate an ambient occlusion value of a vertex in the first vertex set based on the first triangle associated with the vertex in the first vertex set.

12. The apparatus according to claim 10, wherein the processing circuitry is configured to:
calculate areas of the first one or more triangles associated with the first vertex;
acquire sampling points in the first one or more triangles associated with the first vertex; and
calculate the first ambient occlusion value of the first vertex based on the sampling points in the first one or more triangles and the areas of the first one or more triangles.

13. The apparatus according to claim 12, wherein the processing circuitry is configured to:
perform a first interpolation calculation on an opposite edge to the first vertex in a first triangle in the first one or more triangles to obtain first interpolation points of on the opposite edge;
perform second interpolation calculations on interconnecting edges between the first vertex and the first interpolation points to obtain second interpolation points; and
perform sampling on the first triangle based on the second interpolation points.

14. The apparatus according to claim 12, wherein the processing circuitry is configured to:
acquire ambient basic occlusion values of the first vertex respectively for the first one or more triangles based on the sampling points; and
calculate the first ambient occlusion value of the first vertex based on the areas of the first one or more triangles and the ambient basic occlusion values respectively for the first one or more triangles.

15. The apparatus according to claim 14, wherein the processing circuitry is configured to:
acquire sampled ambient occlusion values of the sampling points, a sampled ambient occlusion value of a sampling point being sampled as in a unit sphere of the sampling point; and
average first sampled ambient occlusion values in a first triangle to obtain a first ambient basic occlusion value of the first vertex on the first triangle.

16. The apparatus according to claim 10, wherein the processing circuitry is configured to:
acquire surface normals of the plurality of triangles;
calculate distances from the plurality of vertices to the surface normals; and
calculate the errors associated with the connecting edges based on ambient occlusion values and the distances.

17. The apparatus according to claim 10, wherein the processing circuitry is configured to:
select the first connecting edge that has a current smallest error from the errors in a current round of iteration; and
collapse the first connecting edge to obtain the simplified triangular surface model that is an output of the current round of iteration and an input to a next round of iteration.

18. The apparatus according to claim 17, wherein the processing circuitry is configured to:
recalculate updated errors of updated connecting edges in the simplified triangular surface model in the next round of iteration; and
when the updated errors in the next round of iteration are greater than or equal to an error threshold, determine the simplified triangular surface model that is output from the current round of iteration to be a target triangular surface model to be used for rendering.

19. A non-transitory computer-readable storage medium storing instructions which when executed by at least one processor cause the at least one processor to perform:
performing a triangular surface segmentation on a to-be-processed model to obtain a triangular surface model, the triangular surface model comprising a plurality of triangles and a plurality of vertices, each triangle being associated with three vertices that are connected by connecting edges;
calculating ambient occlusion values respectively of the plurality of vertices, a first ambient occlusion value of a first vertex being calculated based on first one or more triangles associated with the first vertex;
calculating errors respectively associated with a plurality of connecting edges based on the ambient occlusion values of the plurality of vertices; and
collapsing a first connecting edge between two vertices based on the errors to obtain a simplified triangular surface model.

20. The non-transitory computer-readable storage medium according to claim 19, wherein the instructions cause the at least one processor to perform:
grouping the plurality of vertices in the triangular surface model according to normal orientations of the plurality of triangles associated with the plurality of vertices to obtain at least a first vertex set, the first vertex set including first one or more vertices being at least associated with a first triangle; and
calculating an ambient occlusion value of a vertex in the first vertex set based on the first triangle associated with the vertex in the first vertex set.
